(19) United States
(12) Patent Application Publication
(10) Pub. No.: US 2025/0250515 A1
(43) Pub. Date: Aug. 7, 2025

(54) PROCESS FOR MAKING SOLID-DISSOLVABLE COMPOSITION

(71) Applicant: The Procter & Gamble Company, Cincinnati, OH (US)

(72) Inventors: Matthew Lawrence LYNCH, Mariemont, OH (US); Brandon Philip ILLIE, Felicity, OH (US); Karen Diana HUFFORD, Amelia, OH (US); Kristin Rhedrick WILLIAMS, West Chester, OH (US); Jocelyn Michelle MCCULLOUGH, Loveland, OH (US); Vighter IBERI, Mason, OH (US)

(21) Appl. No.: 19/045,636

(22) Filed: Feb. 5, 2025

Related U.S. Application Data
(60) Provisional application No. 63/550,138, filed on Feb. 6, 2024.

(51) Int. Cl. C11D 3/50; C11D 1/04; C11D 3/37; C11D 11/00

(52) U.S. Cl. CPC C11D 3/505; C11D 1/04; C11D 3/3707; C11D 11/0082; C11D 2111/12

(57) ABSTRACT

A process for preparing a solid dissolvable composition comprising perfume capsules dispersed in a crystalline mesh. The crystalline mesh comprises a relatively rigid, three-dimensional, interlocking crystalline skeleton framework of fiber-like crystalline particles formed from crystallizing agents. The process for preparing the solid-dissolvable composition starts with dissolving the crystallizing agent in the perfume capsule slurry (optionally with a small additional amount of aqueous phase), next forming the product stream into the required size and shape for the solid dissolvable composition, and then drying the solid dissolvable composition to the final composition.

### FIELD

A solid dissolvable composition with extraordinarily-high concentration perfume capsules, and an energy-efficient recycle process for creating said composition.

### BACKGROUND

Solid dissolvable compositions of the present invention comprise perfume capsules (with different wall architectures), and optionally other freshness benefit agents, such as neat perfume, pro-perfume, and/or starch encapsulates. Such compositions may be added to a wash, completely dissolve at desired times during the wash, and release active agents to freshen fabrics. Such compositions may comprise small unit dose(s), such as beads.

Fabric freshness products can, in general, be obtained by using a water-soluble carrier for perfume capsules, free perfume and other perfume delivery systems. The particles can comprise a water-soluble carrier. The water-soluble carrier acts to carry the capsules, the free perfume and/or the perfume delivery system to the wash liquor. Upon dissolution-generally under 10 minutes, the water-soluble carrier, the perfume capsules, the other freshness benefit agents are dispersed into the wash liquor and deposited onto the laundry.

As non-limiting examples, the water-soluble carrier can be selected from the group of water-soluble inorganic alkali metal salt, water-soluble alkaline earth metal salt, water-soluble organic alkali metal salt, water-soluble organic alkaline earth metal salt, water-soluble carbohydrate, water-soluble silicate, water-soluble urea, and any combination thereof, including sodium acetate and sodium chloride. The water-soluble carrier can also be selected from the group of water-soluble polymers and block co-polymers, including Pluronic, polyvinyl alcohols, polyvinyl pyrrolidone, starches and modified starches.

One particularly prolific example of water-soluble carrier is polyethylene glycol (PEG). Aouad (U.S. Pat. No. 8,476,219 B2) was the first to describe a freshness composition from small particles composed of PEG entrained with perfume capsules. One of the challenges with such compositions is that they are limited in the amount of perfume capsules (PMC) that can be incorporated in the composition. In practice, perfume capsules are generally not dried, but are supplied as a slurry. Dehydrating the slurry results in increased costs, potential loss of perfume from the perfume capsules, and transportation challenges. The concentration of the perfume capsules in the slurry generally ranges from about 5 wt. % to about 35 wt. % active perfume. This amount limits loading of the perfume capsules to about 1.5 wt. %, in the final composition, because to use more results in the water in the slurry making the PEG composition too soft. As such, when using perfume capsules with PEG, the current compositions (e.g., about one ‘capful’ of about 50 grams) cannot reasonably provide a freshness dose for a large fraction of consumers. Together, this limits freshness experience for consumers, especially those who seek high freshness.

Deflorian, et al., (U.S. Pat. No. 11,499,123 B2; US2023/0037154 A1) discloses water soluble pellets comprising a vegetable soap carrier prepared through an extruder process, and absent the critical elements disclosed in this invention. For example, the disclosed pellets suffer from precarious challenges, such as non-fiber crystal structures (FIG. 1) that result in dense and difficult-to-dissolve pellets, compositions that result in high susceptibility to moisture uptake that may result in supply chain and packaging challenges (FIG. 2), and perfume capsules that may break in the extruder process (FIG. 3). Furthermore, this process also requires chemical processing aids which add potentially-undesirable and costly ingredients to the formulation.

Lynch, et al., (U.S. patent application Ser. No. 18/366,730) shows compositions composed of sodium fatty acid carboxylates to create solid dissolvable compositions with up to about 15 wt. % perfume capsules, overcoming the problems with Deflorian. These compositions show crystalline mesh microstructures (FIG. 4), wherein the final compositions are insensitive to hydration (FIG. 2), wherein the final compositions are thermally stable (FIG. 5), and wherein the perfume capsules survive the making process to deliver superior freshness. Further, blending the chain length of the sodium fatty acid carboxylates enabled different dissolution rates and freshness active agent delivery times to enable enhanced freshness performance. These solid-dissolvable compositions are not prepared by extrusion, but are instead prepared in a three-step making process in which an aqueous mixture of crystallizing agent is mixed with an aqueous mixture of perfume capsules (perfume slurry), then the composition is formed, and then the composition is dried to its final state. Although the process makes a solid-dissolvable composition with higher loading of freshness benefit agents, it also suffers from requiring copious amounts of water that must be later removed at high expense of time and energy, and limits the concentration of perfume capsules to about 15 wt. %. As an example, with this disclosed process, a perfume capsule slurry with 30 wt. % perfume active has ‘water requirement’ of about 2.3 kg of water per 1 kg of solid-dissolvable composition, and a perfume capsule slurry with 5 wt. % perfume active has ‘water requirement’ of about 4.8 kg of water per 1 kg of solid-dissolvable composition. Thus, there is a need for a process that lowers the ‘water requirement’, but that can also enable even higher high perfume capsule loading in the solid-dissolvable composition while having a process slurry with a low enough viscosity for practical mixing during the making.

In this disclosure, we share an inventive process with surprising results that maintains the advantages discovered by Lynch, et al., (U.S. patent application Ser. No. 18/366,730)—e.g., similar fiber microstructure (FIG. 6A, FIG. 6B, FIG. 6C)—while significantly decreasing the water requirement, increasing the potential for loading perfume capsules in the solid-dissolvable composition, and having manageable process slurry viscosity. Further, it is surprising that particular two-temperature step cooling techniques can be employed to speed the crystallization process and create firmer compositions. The process has a water requirement of less than about 2.0 kg·kg⁻¹, has a process slurry low shear viscosity (Viscosity (0.1 s⁻¹)) of less than about 100 Pas and a high shear viscosity (Viscosity (100 s⁻¹)) of less than about 2 Pa·s, which enables mixing and can result in solid-dissolvable compositions with perfume capsule loading of from about 12 wt. % to about 70 wt. %. A two-temperature step cooling approach to pre-crystallize some fraction of the crystallizing agent and final crystallize the balance of the crystallizing agent, results in a faster process with firmer compositions. The process may be used for compositions comprising sodium octanoate, sodium decanoate, sodium dodecanoate, or mixtures thereof.

### SUMMARY

A process of making a solid-dissolvable composition comprising:
a) providing a perfume capsule slurry comprising perfume capsules and water, wherein the perfume capsules have a mass of perfume capsules and the water has a perfume capsule slurry water mass;
b) creating a process slurry by mixing the perfume capsule slurry with a crystallizing agent having a mass of crystallizing agent, and adding from about 0% to about 30%, by weight of the process slurry, extra water, having an extra water mass;
   i) wherein the low shear viscosity of the process slurry (Viscosity (0.1 s⁻¹)) is less than about 100 Pa·s and the high shear viscosity (Viscosity (100 s⁻¹)) is less than about 2 Pa·s as determined by the RHEOLOGY TEST METHOD;
   ii) wherein the water requirement of the process slurry is less than about 2.0 kg·kg⁻¹; and
   iii) wherein the process slurry is such that the (mass of perfume capsules)/(mass of perfume capsules+mass of crystallizing agent) is greater than 0.2;
c) crystallizing the crystallizing agent;
d) drying to remove water until the solid dissolvable composition comprises less than 10 wt % water.

### BRIEF DESCRIPTION OF THE DRAWINGS

While the specification concludes with claims particularly pointing out and distinctly claiming the subject matter that is regarded as the present disclosure, it is believed that the disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of elements in any of the exemplary embodiments, except as may be explicitly delineated in the corresponding written description. None of the drawings are necessarily to scale.

FIG. 1A and FIG. 1B are electron micrographs of compositions disclosed in Deflorian, et al., (U.S. Pat. No. 11,499,123 B2; US2023/0037154 A1); FIG. 1A shows a composition that was prepared at 25° C. and FIG. 1B shows a composition that was prepared at 33° C. Neither composition shows the inventive microstructure of the present invention.

FIG. 2 is a graph comparing the hydration properties of Deflorian, et al., (U.S. Pat. No. 11,499,123 B2; US2023/0037154 A1) and a commercial face cleaner to those compositions described in Lynch, et al., (U.S. patent application Ser. No. 18/366,730). The first two compositions show significant water gain (% dm) in the composition when exposed to less than 60% RH, as determined by the Humidity Test Method. The final composition shows no significant water gain (% dm) until it is exposed to more than 90% RH. Those compositions described in Lynch, et al., will be therefore more robust in a product in the supply chain, on shelf, and with consumer use.

FIG. 3 is an electron micrograph of a composition described by Deflorian, et al., (U.S. Pat. No. 11,499,123), showing broken perfume capsules from tablet making, which delivers high stress and strain akin to an extruder process.

FIG. 4A, FIG. 4B, and FIG. 4C are electron micrographs of compositions described in Lynch, et al., (U.S. patent application Ser. No. 18/366,730); FIG. 4A, FIG. 4B, and FIG. 4C show the microstructure from the sodium fatty acid carboxylate crystals in the absence of perfume capsules at different magnifications clearly showing fiber and resulting mesh microstructure.

FIG. 5 is a graph showing the thermal stability of composition described in Lynch, et al., (U.S. patent application Ser. No. 18/366,730), as determined by the Thermal Stability Test Method. There are no significant changes in the compositions until the temperature exceeds 100° C.

FIG. 6A, FIG. 6B, and FIG. 6C are electron micrographs of inventive compositions described in this invention. FIG. 4A shows fiber crystals of sodium fatty acid carboxylate in the presence of 13.3 wt. % of perfume capsules (i.e., Sample AA); FIG. 6A shows fiber crystals of sodium fatty acid carboxylate in the presence of 35 wt. % of perfume capsules (i.e., Sample AE); and FIG. 6B shows fiber crystals of sodium fatty acid carboxylate in the presence of 50 wt. % of perfume capsules (i.e., Sample AH).

FIG. 7A and FIG. 7B are electron micrographs of non-inventive compositions that show that non-fiber-like crystals result when the composition is prepared not having sodium with the fatty acid carboxylate; FIG. 7A shows plate-like crystals of potassium fatty acid carboxylate and FIG. 7B shows plate-like crystals of triethanolamine fatty acid carboxylate.

FIG. 8 is a graph of inventive non-limiting examples, showing the amount of crystallizing agent in kg added to a 100 kg of slurry in tank containing 32 wt. % perfume capsules (x-axis) and water requirements in making the composition (left y-axis, blue triangles) in kg water per kg solid-dissolvable composition, where the calculation require a 30 wt. % crystallizing agent in water for processability. In this example, there is sufficient water from the slurry when adding less than about 30 kg of crystallizing agent, such that the amount of water requirements approach 1 kg water per 1 kg of solid-dissolvable composition (‘excess water’). There is insufficient water from the slurry when adding more than about 30 kg of crystallizing agent and water must be added to tank (‘add water’). However, in all cases the water requirement remain less than 2 kg water per 1 kg solid-dissolvable composition, preferred composition are cases the water requirement remain less than 1.5 kg, where the most preferred composition are cases the water requirement approach 1 kg per kg of solid-dissolvable composition. In addition to minimizing the water requirements, the inventive process also enables higher loading of perfume capsules in the final solid-dissolvable composition (right y-axis, red circles), where the perfume capsule limit from Lynch, et al., is given by the horizontal dashed line at 0.15 (i.e., 15 wt. %) along the bottom of the plot.

FIGS. 9A and 9B are graphs showing the effect of cooling steps on the rate of crystallization in Example AA done with the MODULUS TEST METHOD. FIG. 9A. shows a one-step and two-step cooling profile. The one-step process example (dashed) maintains the temperature of the process slurry at 40° C., and reduces the temperature in a single step to 5° C.; the more preferred two-step process example (solid) maintains the temperature of the process slurry at 40° C., then steps to 25° C. for 1200 second to reach steady state, and then reduces the temperature to 5° C. FIG. 9B. shows the effect on temperature steps on building the mesh structure, as the elastic modulus (G′). In a surprising contrast, the one-step process example (dashed) show a very long delay time (ΔT) of about 800 seconds before the microstructure begins to form, and then the microstructure builds (small α) relatively slow, while the more preferred two-step process example (solid) show no delay time of about 800 seconds before the microstructure begins to form, and then the microstructure builds relatively fast (large a).

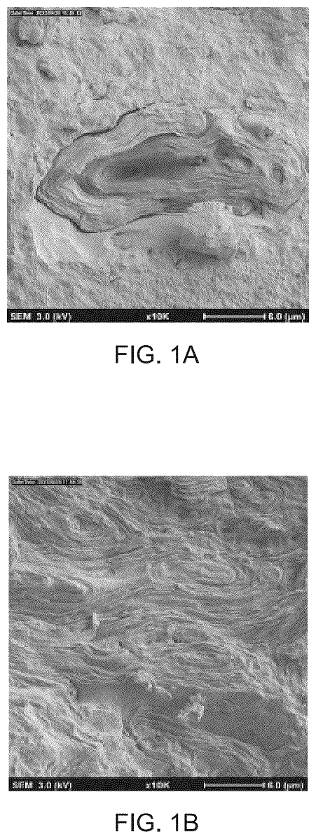

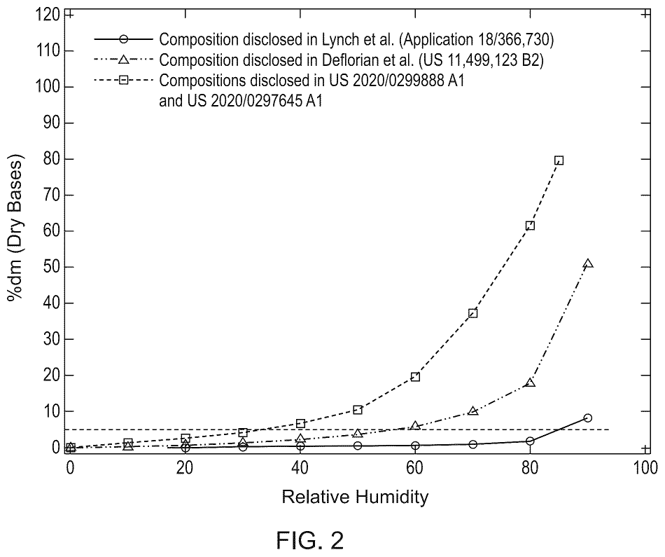

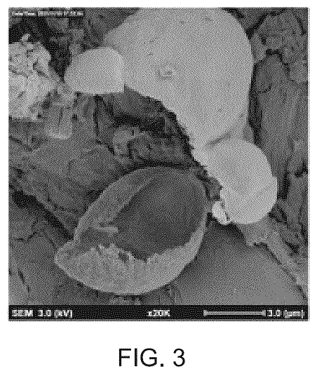

### DETAILED DESCRIPTION OF THE INVENTION

The present invention includes a process for preparing a solid dissolvable composition comprising perfume capsules dispersed in a crystalline mesh. The crystalline mesh (“mesh”) comprises a relatively rigid, three-dimensional, interlocking crystalline skeleton framework of fiber-like crystalline particles formed from crystallizing agents. The process for preparing the solid-dissolvable composition starts with dissolving the crystallizing agent in the perfume capsule slurry (optionally with a small additional amount of aqueous phase), next forming the product stream into the required size and shape for the solid dissolvable composition, and then drying the solid dissolvable composition to the final composition.

The present invention may be understood more readily by reference to the following detailed description of illustrative compositions. It should be understood that the scope of the claims is not limited to the specific products, methods, conditions, devices, or parameters described herein, and that the terminology used herein is not intended to be limiting of the claimed invention.

“Solid-Dissolvable Composition,” (SDC), as used herein comprises crystallizing agents sodium octanoate, sodium decanoate and sodium dodecanoate and mixture therein, when processed as described in the specification, form an interconnected crystalline mesh of fibers that readily dissolve at target wash temperatures, at least one freshness benefit agent of perfume capsules, less than about 10 wt. % of the water, and optionally an additional benefit agent of neat perfume, pro-perfume or starch encapsulates. The solid-dissolvable composition may be in a solid form such as a powder, a particle, an agglomerate, a flake, a granule, a pellet, a tablet, a lozenge, a puck, a briquette, a brick, a solid block, a unit dose, a ‘Cheetos’ shape, a ‘Hersey-kiss’ shape, or other solid form known to those of skill in the art. Herein, a ‘bead’ is a particular solid form, having a hemi-spherical shape with the preferred embodiment with a radius of between about a 1.0 mm and about 5.0 mm and mass between about 5-100 mg, with a more preferred embodiment with a radius of between about a 2.0 mm and about 4.0 mm and mass between about 5-50 mg, with the most preferred embodiment with a radius of about a 2.5 mm and mass between about 10-30 mg.

“Fabric Treatment Composition,” as used herein comprises one or more particles of solid-dissolvable compositions added to the wash drum at the start of wash cycle to freshen fabrics. In embodiments with two or more solid-dissolvable compositions, the compositions may have the same composition or the compositions may have different compositions, such as containing different types of perfume capsules.

“Crystallizing agent,” as used herein comprises primarily sodium octanoate, sodium decanoate and sodium dodecanoate, and mixtures thereof.

“Fiber’, as used herein comprises crystallized crystallizing agent in the shape of a thread or an object resembling a thread, as determined by the FIBER TEST METHOD.

“Freshness benefit agent,” as used herein comprises perfume capsules, neat perfume, pro-perfumes and starch complexes, added to wash to impart freshness (scent) benefits to fabric during a wash.

“Perfume capsules,” as used herein comprises perfume accords encapsulated by different materials in non-limiting examples of urea, methyl formaldehyde, silica, and chitosan.

“Perfume capsule slurry,” as used herein comprises perfume capsules dispersed in an aqueous mixture containing primarily water with other possible adjuncts (e.g., polymer) to stabilize the dispersion. The perfume capsules are received from supplies generally with between about 5 wt. % and about 35 wt. % active perfume.

“Process slurry,” as used herein describes a composition containing perfume capsule slurry, crystallizing agent and optionally added water, created as an intermediate in a disclosed process for preparing solid-dissolvable compositions. The mass fraction of perfume capsules in the process slurry is defined as ϕ_{pc}=M_{pc}/(M_{pc}+M_{w}) and the mass fraction of crystallizing agents in the process slurry is defined as ϕ_{ca}=M_{ca}/(M_{ca}+M_{w}), both being important to the flowability.

“One-temperature step process,” making process in which the process slurry is cooled to the final crystallization temperature in a single step.

“Two-temperature step process,” making process in which the process slurry is cooled to an intermediate temperature (pre-crystallize) the crystallizing agent, and then cooled to the final crystallization temperature (final-crystallize).

“Crystallization point,” is the temperature at which the solubilized crystallizing agent in the process slurry begins to crystallize. With preferred mixtures of crystallizing agent, this temperature is less than about 35 deg. C. One skilled in the art understands how to measure this temperature with a Differential Scanning Calorimetry (DSC) instrument.

“Water requirement,” as used herein indicates the mass of water required to prepare 1 kg mass of inventive solid-dissolvable composition, and is expressed in units of kg water per kg of solid-dissolvable composition (i.e., kg·kg⁻¹). In preferred embodiments, the water requirement is less than about 2.0 kg·kg⁻¹, more preferred water requirement is less than 1.5 kg·kg⁻¹, and more preferred water requirement is less than 1.25 kg·kg⁻¹, the most preferred water requirement are less than 1.00 kg·kg⁻¹. The water requirement may be calculated as the mass of all water in the process slurry (perfume capsule slurry water mass plus extra water mass) divided by the mass of the final solid-dissolvable composition.

“Stability temperature,” as used herein is the temperature at which most (or all) of the SDC material completely melts, such that a composition no longer exhibits a stable solid structure and may be considered a liquid or paste, and the solid dissolvable composition no longer functions as intended. The stability temperature is the lowest temperature thermal transition, as determined by the THERMAL STABILITY TEST METHOD. In embodiments of the present invention the stability temperature may be greater than about 40° C., more preferably greater than about 50° C., more preferably greater than about 60° C., and most preferably greater than about 70° C., to ensure stability in the supply chain. One skilled in the art understands how to measure the lowest thermal transition with a Differential Scanning Calorimetry (DSC) instrument.

“Humidity stability,” as used herein is the relative humidity at which the low water composition spontaneously absorbs more than 5 wt. % (% dm) of the original mass in water from the humidity from the surrounding environment, at 25° C. Absorbing low amounts of water when exposed to humid environments enables more sustainable packaging. Absorbing high amounts of water risks softening or liquifying the composition, such that it no longer functions as intended. In embodiments of the present invention the humidity stability may be above 70% RH, more preferably above 80% RH, more preferably above 90% RH, the most preferably above 95% RH. One skilled in the art understands how to measure 5 wt. % weight gain with a Dynamic Vapor Sorption (DVS) instrument, further described in the HUMIDITY TEST METHOD.

“Dissolve during normal use,” as used herein means that the solid dissolvable composition completely or substantially dissolves during use in an aqueous environment, such as wash cycles. Suitable compositions and microstructures enable dissolution rates greater than M_{A}>5% at solubility temperature at 37° C. and more preferably dissolution rates greater than M_{A}>5% solubility temperature at 25° C. by the DISSOLUTION TEST METHOD for desired dissolution profiles under wash conditions.

As used herein, the term “bio-based” material refers to a renewable material.

As used herein, the term “renewable material” refers to a material that is produced from a renewable resource. As used herein, the term “renewable resource” refers to a resource that is produced via a natural process at a rate comparable to its rate of consumption (e.g., within a 100-year time frame). The resource can be replenished naturally, or via agricultural techniques. Non-limiting examples of renewable resources include plants (e.g., sugar cane, beets, corn, potatoes, citrus fruit, woody plants, lignocellulose, hemicellulose, cellulosic waste), animals, fish, bacteria, fungi, and forestry products. These resources can be naturally occurring, hybrids, or genetically engineered organisms. Natural resources, such as crude oil, coal, natural gas, and peat, which take longer than 100 years to form, are not considered renewable resources. Because at least part of the material of the invention is derived from a renewable resource, which can sequester carbon dioxide, use of the material can reduce global warming potential and fossil fuel consumption.

As used herein, the term “bio-based content” refers to the amount of carbon from a renewable resource in a material as a percent of the weight (mass) of the total organic carbon in the material, as determined by ASTM D6866-10 Method B.

The term “solid” refers to the physical state of the composition under the expected conditions of storage and use of the solid dissolvable composition.

As used herein, the articles including “a” and “an” when used in a claim, are understood to mean one or more of what is claimed or described.

As used herein, the terms “include,” “includes” and “including” are meant to be non-limiting.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Crystallizing Agent

Crystallizing agents are sodium fatty acid carboxylates, primarily sodium octanoate, sodium decanoate and sodium dodecanoate, and mixtures thereof. In the disclosed compositional range and prepared by the disclosed process, such sodium fatty acid carboxylates provide a fibrous mesh microstructure, suitable solubilization temperature, suitable dissolution times, preferred humidity stability and preferred stability temperature.

Further, blending the crystallization agents results in a solid dissolvable compositions have tunability in these properties for varied uses and conditions. Suitable combinations of crystallization agent combinations are described in Lynch, et al., (U.S. patent application Ser. No. 18/366,730). One particularly suitable combination for the present invention is 50 wt. % to 70 wt. % NaCl2, 15 wt. % to 25 wt. % NaCl0, and 15 wt. % to 25 wt. % NaC8.

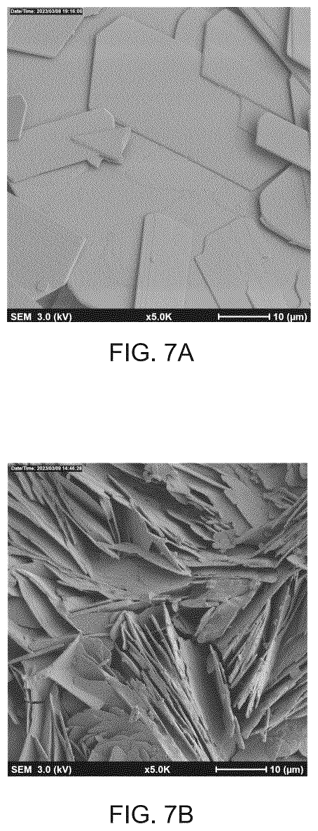

‘Like’ crystallizing agent- or fatty acid carboxylate without sodium counter ions, are unsuitable for this invention. For example, potassium fatty acid carboxylate (FIG. 7A) and triethanolamine fatty acid carboxylate (FIG. 7B) demonstrate non-fiber crystals.

The crystallizing agents are selected from the small group sodium fatty acid carboxylates having saturated chains and with chain lengths ranging from C8-C12. In this compositional range and with the described method of preparation, such sodium fatty acid carboxylates provide a fibrous mesh microstructure, ideal solubilization temperature for making and dissolution in use, and, by suitable blending, the resulting solid dissolvable compositions have tunability in these properties for varied uses and conditions.

Crystallizing agents may be present in Solid Dissolvable Composition Mixtures in an amount of from about between about 5 wt % to about 50 wt %, between about 10 wt % to about 35 wt %, between about 15 wt % to about 35 wt %. Crystallizing agents may be present in the Solid Dissolvable Composition in an amount of from about 50 wt % to about 99 wt %, between about 60 wt % to about 95 wt %, and between about 70 wt % to about 90 wt %.

Suitable crystallizing agents include sodium octanoate (NaC8), sodium decanoate (NaCl0), sodium dodecanoate or sodium laurate (NaCl2) and combinations thereof.

### Perfume Capsule Slurry

Perfume capsule slurry is prepared by suppliers (e.g., Milliken) and used to add perfume capsules to the solid-dissolvable composition. Perfume capsules are prepared from oil-in-water emulsions by polymerizing a surfactant active agent at the interface between the phases of the emulsion, creating the wall of the capsule. Non-limiting examples of perfume capsule wall materials include urea, silica, chitosan, and methyl formaldehyde. The result of this preparation is a perfume capsule slurry—or a slurry of perfume capsules dispersed in an aqueous phase. The aqueous phase on the slurry may contain reactive byproducts from creating the capsule walls. The aqueous phase on the slurry may also contain stabilizing agents such as 1 wt. % xanthan gum to ensure the capsules remain uniformly dispersed in the aqueous phase. The concentration of the perfume capsules in the slurry generally ranges from about 5 wt. % to about 35 wt. % active perfume. The perfume capsules are generally not dried nor supplied as powders, because dried capsules in the absence of crystallizing agents can become brittle and break in transit. Dried capsules also can cake, making them difficult to redisperse and making them have such high activity that they may no longer be easily transported.

### Perfume Capsule Material

A capsule (active agent delivery capsule or just “capsule”) may include a wall material that encapsulates an active agent (as described below), such as a freshness benefit agent. Freshness benefit agent may be referred herein as a “benefit agent,” “encapsulated active agent,” or an “encapsulated benefit agent”. The encapsulated active agent is encapsulated in the core. A benefit agent may be at least one of: a perfume mixture or a malodor counteractant, or combinations thereof. A benefit agent may include materials selected from the group consisting of perfume raw materials such as 3-(4-t-butylphenyl)-2-methyl propanal, 3-(4-t-butylphenyl)-propanal, 3-(4-isopropylphenyl)-2-methylpropanal, 3-(3,4-methylenedioxyphenyl)-2-methylpropanal, and 2,6-dimethyl-5-heptenal, alpha-damascone, beta-damascone, gamma-damascone, beta-damascenone, 6,7-dihydro-1,1,2,3,3-pentamethyl-4(5H)-indanone, methyl-7,3-dihydro-2H-1,5-benzodioxepine-3-one, 2-[2-(4-methyl-3-cyclohexenyl-1-yl)propyl]cyclopentan-2-one, 2-sec-butylcyclohexanone, and beta-dihydro ionone, linalool, ethyllinalool, tetrahydrolinalool, and dihydromyrcenol; silicone oils, waxes such as polyethylene waxes; essential oils such as fish oils, jasmine, camphor, lavender; skin coolants such as menthol, methyl lactate; vitamins such as Vitamin A and E; sunscreens; glycerin; catalysts such as manganese catalysts or bleach catalysts; bleach particles such as perborates; silicon dioxide particles; antiperspirant actives; cationic polymers and mixtures thereof. Suitable benefit agents can be obtained from Givaudan Corp. of Mount Olive, New Jersey, USA, International Flavors & Fragrances Corp. of South Brunswick, New Jersey, USA, or Firmenich Company of Geneva, Switzerland or Milliken Company of Appleton, Wisconsin (USA). As used herein, a “perfume raw material” refers to one or more of the following ingredients: fragrant essential oils; aroma compounds; materials supplied with the fragrant essential oils, aroma compounds, stabilizers, diluents, processing agents, and contaminants; and any material that commonly accompanies fragrant essential oils, aroma compounds.

The wall (or shell) material of the active agent delivery capsule may comprise: melamine, polyacrylamide, silicones, silica, polystyrene, polyurea, polyurethanes, polyacrylate based materials, polyacrylate esters based materials, gelatin, styrene malic anhydride, polyamides, aromatic alcohols, polyvinyl alcohol and mixtures thereof. The melamine wall material may comprise melamine crosslinked with formaldehyde, melamine-dimethoxyethanol crosslinked with formaldehyde, and mixtures thereof. The polystyrene wall material may comprise polyestyrene cross-linked with divinylbenzene. The polyurea wall material may comprise urea crosslinked with formaldehyde, urea crosslinked with gluteraldehyde, polyisocyanate reacted with a polyamine, a polyamine reacted with an aldehyde and mixtures thereof. The polyacrylate based wall materials may comprise polyacrylate formed from methylmethacrylate/dimethylaminomethyl methacrylate, polyacrylate formed from amine acrylate and/or methacrylate and strong acid, polyacrylate formed from carboxylic acid acrylate and/or methacrylate monomer and strong base, polyacrylate formed from an amine acrylate and/or methacrylate monomer and a carboxylic acid acrylate and/or carboxylic acid methacrylate monomer, and mixtures thereof.

The polyacrylate ester-based wall materials may comprise polyacrylate esters formed by alkyl and/or glycidyl esters of acrylic acid and/or methacrylic acid, acrylic acid esters and/or methacrylic acid esters which carry hydroxyl and/or carboxy groups, and allylgluconamide, and mixtures thereof.

The aromatic alcohol-based wall material may comprise aryloxyalkanols, arylalkanols and oligoalkanolarylethers. It may also comprise aromatic compounds with at least one free hydroxyl-group, especially preferred at least two free hydroxy groups that are directly aromatically coupled, wherein it is especially preferred if at least two free hydroxy-groups are coupled directly to an aromatic ring, and more especially preferred, positioned relative to each other in meta position. It is preferred that the aromatic alcohols are selected from phenols, cresols (o-, m-, and p-cresol), naphthols (alpha and beta-naphthol) and thymol, as well as ethylphenols, propylphenols, fluorphenols and methoxyphenols.

The polyurea based wall material may comprise a polyisocyanate.

The polyvinyl alcohol-based wall material may comprise a crosslinked, hydrophobically modified polyvinyl alcohol, which comprises a crosslinking agent comprising i) a first dextran aldehyde having a molecular weight of from 2,000 to 50,000 Da; and ii) a second dextran aldehyde having a molecular weight of from greater than 50,000 to 2,000,000 Da.

The wall (shell) material may comprise the reaction product of a biopolymer and a cross-linking agent.

The biopolymer may preferably be selected from the group consisting of a polysaccharide, a protein, a nucleic acid, a polyphenolic compound, derivatives thereof, and combinations thereof. Preferably, the biopolymer is selected from the group consisting of:
(a) a polysaccharide selected from the group consisting of chitosan, starch, modified starch, dextran, maltodextrin, dextrin, cellulose, modified cellulose, hemicellulose, chitin, alginate, lignin, gum, pectin, fructan, carrageenan, agar, pullulan, suberin, cutin, cutan, melanin, silk fibronin, derivatives thereof, and combinations thereof;
(b) a protein selected from the group consisting of gelatin, collagen, casein, sericin, fibroin, whey protein, zein, soy protein, plant storage protein (plant protein isolate, plant protein concentrate), gluten, peptide, actin, derivatives thereof, and combinations thereof;
(c) a nucleic acid selected from the group consisting of polynucleotides, RNA, DNA, derivatives thereof, and combinations thereof;
(d) a polyphenolic compound selected from the group consisting of tannins, lignans, derivatives thereof, and combinations thereof; or
(e) combinations thereof.

The biopolymer preferably comprises primary amine groups. The primary amine groups can react with the cross-linking agents, preferably polyisocyanates, to form the polymeric material, which may be described as a cross-linked biopolymer.

Amine-containing biopolymers, such as amine-containing or amine-modified saccharides, may be preferred, for example due to convenient availability, biodegradability, and/or performance reasons. A particularly preferred material is chitosan. Thus, the biopolymer may preferably be chitosan, a derivative thereof, or a combination thereof. Preferably, the biopolymer is acid-treated chitosan, redox-initiator-treated chitosan, a derivative thereof, or a combination thereof.

The biopolymer, preferably chitosan, more preferably acid-treated chitosan, may preferably be characterized by a molecular weight of from about 1 kDal to about 1000 kDal, preferably from about 50 kDal to about 600 kDal, more preferably from about 100 kDal to about 500 kDal, even more preferably from about 100 kDal to about 300 kDal, even more preferably from about 100 kDal to about 200 kDal. The chitosan, when present, may comprise anionically modified chitosan, cationically modified chitosan, or a combination thereof. material that is the reaction product of the biopolymer chitosan and a cross-linking agent.

The cross-linking material is preferably a material selected from the group consisting of a polyisocyanate, a polyacrylate, a poly(meth)acrylate, a polyisothiocyanate, an aldehyde, an epoxy compound, a polyphenol, a carbonyl halide, an aziridine, and combinations thereof. The cross-linking agent is more preferably selected from the group consisting of a polyisocyanate, an epoxy compound, a bifunctional aldehyde, and combinations thereof.

The polyisocyanate, when aromatic, can be, but is not limited to, methylene diphenyl isocyanate, toluene diisocyanate, tetramethylxylidene diisocyanate, polyisocyanurate of toluene diisocyanate (commercially available from Bayer under the tradename Desmodur® RC), trimethylol propane-adduct of toluene diisocyanate (commercially available from Bayer under the tradename Desmodur® L75), or naphthalene-1,5-diisocyanate, and phenylene diisocyanate.

Aliphatic polyisocyanates may include a trimer of hexamethylene diisocyanate, a trimer of isophorone diisocyanate, a trimethylol propane-adduct of hexamethylene diisocyanate (available from Mitsui Chemicals) or a biuret of hexamethylene diisocyanate (commercially available from Bayer under the tradename Desmodur® N 100), or trimethylol propane-adduct of xylylene diisocyanate (commercially available from Mitsui Chemicals under the tradename Takenate® D-110N),

Derivatives of polyisocyanates may include oligomers or polymers of isocyanate monomers. As a non-limiting example, the polyisocyanate may preferably comprise an oligomer or polymer of diphenylmethane diisocyanate (MDI), such as Mondur® MR-Light.

The polyisocyanate may preferably be selected from the group consisting of: a polyisocyanurate of toluene diisocyanate; a trimethylol propane adduct of toluene diisocyanate; a trimethylol propane adduct of xylylene diisocyanate; 2,2′-methylenediphenyl diisocyanate; 4,4′-methylenediphenyl diisocyanate; 2,4′-methylenediphenyl diisocyanate; [diisocyanato (phenyl)methyl]benzene; toluene diisocyanate; tetramethylxylidene diisocyanate; naphthalene-1,5-diisocyanate; 1,4-phenylene diisocyanate; 1,3-diisocyanatobenzene; derivatives thereof (such as pre-polymers, oligomers, and/or polymers thereof); and combinations thereof.

The composition may comprise from about 0.05% to about 20%, or from about 0.05% to about 10%, or from about 0.1% to about 5%, or from about 0.2% to about 2%, by weight of the composition, of active agent delivery capsules. The composition may comprise enough active agent delivery capsules to provide from about 0.05% to about 10%, or from about 0.1% to about 5%, or from about 0.1% to about 2%, by weight of the composition, of the encapsulated active agent, which may preferably be perfume raw materials, to the composition. When discussing herein the amount or weight percentage of the active agent delivery capsules, it is meant the sum of the wall material and the core material.

The active agent delivery capsules according to the present disclosure may be characterized by a volume-weighted median particle size from about 1 to about 100 microns, preferably from about 10 to about 100 microns, preferably from about 15 to about 50 microns, more preferably from about 20 to about 40 microns, even more preferably from about 20 to about 30 microns. Different particle sizes are obtainable by controlling droplet size during emulsification.

The active agent delivery capsules may be characterized by a ratio of core to shell up to 99:1, or even 99.5:1, based on weight.

The core of the active agent delivery capsules of the present disclosure may comprise a partitioning modifier, which may facilitate more robust shell formation. The partitioning modifier may be combined with the core's perfume oil material prior to incorporation of the wall-forming monomers. The partitioning modifier may be present in the core at a level of from about 5% to about 55%, preferably from about 10% to about 50%, more preferably from about 25% to about 50%, by weight of the core.

The partitioning modifier may comprise a material selected from the group consisting of vegetable oil, modified vegetable oil, mono-, di-, and tri-esters of C4-C24 fatty acids, isopropyl myristate, dodecanophenone, lauryl laurate, methyl behenate, methyl laurate, methyl palmitate, methyl stearate, and mixtures thereof. The partitioning modifier may preferably comprise or even consist of isopropyl myristate. The modified vegetable oil may be esterified and/or brominated. The modified vegetable oil may preferably comprise castor oil and/or soy bean oil. US Patent Application Publication 20110268802, incorporated herein by reference, describes other partitioning modifiers that may be useful in the presently described active agent delivery capsules.

The active agent capsule may be coated with a deposition aid, a cationic polymer, a non-ionic polymer, an anionic polymer, or mixtures thereof. Suitable polymers may be selected from the group consisting of: polyvinyl formaldehyde, partially hydroxylated polyvinyl formaldehyde, polyvinyl amine, polyethyleneimine, ethoxylated polyethyleneimine, polyvinyl alcohol, polyacrylates, and combinations thereof. The freshening composition may include one or more types of active agent delivery capsules, for example two active agent delivery capsule types, wherein one of the first or second active agent delivery capsules (a) has a wall made of a different wall material than the other; (b) has a wall that includes a different amount of wall material or monomer than the other; or (c) contains a different amount perfume oil ingredient than the other; (d) contains a different perfume oil; (e) has a wall that is cured at a different temperature; (f) contains a perfume oil having a different c Log P value; (g) contains a perfume oil having a different volatility; (h) contains a perfume oil having a different boiling point; (i) has a wall made with a different weight ratio of wall materials; (j) has a wall that is cured for different cure time; and (k) has a wall that is heated at a different rate.

### Neat Perfume Materials

The solid dissolvable composition may include unencapsulated perfume comprising one or more perfume raw materials that solely provide a hedonic benefit (i.e., that do not neutralize malodors yet provide a pleasant fragrance). Suitable perfumes are disclosed in U.S. Pat. No. 6,248,135. For example, the solid dissolvable composition may include a mixture of volatile aldehydes for neutralizing a malodor and hedonic perfume aldehydes. Where perfumes, other than the volatile aldehydes in the malodor control component, are formulated into the solid dissolvable composition.

In preferred embodiments, the neat perfume levels are less than about 20 wt. %, in more preferred embodiments, the neat perfume levels are less than about 10 wt. %, in more preferred embodiments, the neat perfume levels are between about 0.5 wt. % and 10 wt. %, in the most preferred embodiments, the neat perfume levels are between about 1.0 wt. % and 10 wt. %,

### Pro-Perfume Materials

The freshness systems of the present disclosure may comprise pro-perfume materials. Sometimes referred to as pro-fragrances or fragrance precursors, pro-perfume materials typically comprise a covalent bond between a carrier and one or more perfume raw materials. The one or more perfume raw materials are then released upon exposure to a trigger, such as water or light, which breaks the bond, for example by hydrolysis. Pro-perfume materials can provide extended PRM release profiles, resulting in long-lasting freshness benefits.

Non-limiting examples of pro-perfumes include Michael adducts (e.g., beta-amino ketones), aromatic or non-aromatic imines (Schiffs Bases), oxazolidines, beta-keto esters, and orthoesters. Another aspect includes compounds comprising one or more beta-oxy or beta-thio carbonyl moieties capable of releasing a PRM, for example, an alpha, beta-unsaturated ketone, aldehyde or carboxylic ester. Certain silicon-containing compounds may be suitable pro-perfumes, such as silicic acid esters, polysilicic acid esters, and certain silicone polymers.

The pro-perfume may be a silicone-based pro-perfume, preferably an aminosilicone-based pro-perfume. The PRMs may covalently bond with the silicone compound, for example by forming an imine bond with a primary amine group of an aminosilicone, in one or more terminal or non-terminal, including pendant, positions of a silicone backbone. Silicones may be particularly preferred as pro-perfume carriers in that they may facilitate improved deposition of the PRM fragments onto a target surface, such as a fabric, prior to the release of the PRM. Such silicone-based delivery technologies are further disclosed in US Patent Application 2016/0137674A1 (assigned to The Procter & Gamble Company), incorporated herein by reference.

The pro-perfume may be an Amine Reaction Product (ARP), where a compound comprising amine functionality is reacted with one or more PRMs, typically PRMs that contain a ketone moiety and/or an aldehyde moiety. Typically, the reactive amines are primary and/or secondary aminese and may be part of a polymer or a monomer (non-polymer).

The compound may be a polymeric amine. Non-limiting examples of polymeric amines include polymers based on polyalkylimines, such as polyethyleneimine (PEI), or polyvinylamine (PVAm). Non-limiting examples of monomeric (non-polymeric) amines include hydroxyl amines, such as 2-20 aminoethanol and its alkyl substituted derivatives, and aromatic amines such as anthranilates.

A material that contains a heteroatom other than nitrogen, for example oxygen, sulfur, phosphorus or selenium, may be used as an alternative to, or in addition to, amine compounds. In yet another aspect, a single molecule may comprise an amine moiety and one or more of the alternative heteroatom moieties, for example, thiols, phosphines and selenols.

The pro-perfume material may be selected from the group consisting of an amine-containing compound, an alkylidene-containing compound, a silicon-containing compound, and mixtures thereof.

The pro-perfume material may comprise an amine-containing compound, preferably a polymeric amine, more preferably an aminosilicone.

The pro-perfume material may comprise an alkylidene-containing compound, preferably an alkylidene-containing compound according to formula (I):

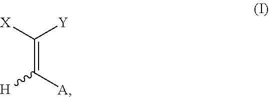

wherein: A is a hydrocarbon residue of an aldehyde-containing perfume raw material (e.g., A-CHO), wherein the hydrocarbon residue may optionally contain one or more heteroatom(s) selected from the group consisting of oxygen, nitrogen, sulfur, silicon, and mixtures thereof; and X and Y are independently selected from the group consisting of a nitrile group (—CN), a keto group (—C(O) R), and an ester group (—C(O) OR′), wherein R and R′ are independently alkyl groups having from one to ten carbon atoms, preferably alkyl groups independently selected from methyl, ethyl, propyl, isopropyl, butyl, sec-butyl, iso-butyl, and pentyl groups. Suitable alkylidene-containing compounds are described in more detail in WO2018/096176 (to Givaudan SA).

In the pro-perfume material that is the alkylidene-containing compound according to formula (I), it may be that X and Y are not both keto groups.

In the pro-perfume material that is the alkylidene-containing compound according to formula (I), it may be that X and Y represent different functional groups, preferably wherein one group of X and Y is an ester group, and the other group is a keto group, more preferably wherein the alkylidene double bond is enriched in its Z-isomer. It is believed that the Z-isomer is less likely to form a double-bond-shifted product that is inactive as a pro-perfume, compared to the related E-isomer.

The pro-perfume material may be an alkylidene-containing compound according to formula (II):

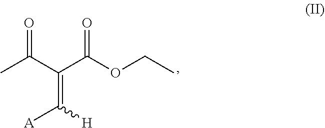

preferably wherein the alkylidene double bond is enriched in its Z-isomer.

In preferred embodiments, the properfume levels are less than about 20 wt. %, in more preferred embodiments, the properfume levels are less than about 10 wt. %, in more preferred embodiments, the properfume levels are between about 0.5 wt. % and 10 wt. %, in the most preferred embodiments, the properfume levels are between about 1.0 wt. % and 10 wt. %,

### Solid Dissolvable Composition

A solid-dissolvable composition comprises crystallizing agent, water, perfume capsules and optionally, other freshness benefits including neat perfume, pro-perfume, and/or starch encapsulates.

In one embodiment, the solid-dissolvable composition comprises 30 wt. %-88 wt. % crystallizing agent, in a more preferred embodiment, the solid-dissolvable composition comprises 65 wt. %-86 wt. % crystallizing agent, in a more preferred embodiment the solid-dissolvable composition comprises 72 wt. %-85 wt. % crystallizing agent, in the most preferred embodiment the solid-dissolvable composition comprises 80 wt. %-88 wt. % crystallizing agent.

One particularly suitable combination for the present invention is 50 wt. % to 70 wt. % NaCl2, 15 wt. % to 25 wt. % NaCl0, and 15 wt. % to 25 wt. % NaC8.

In one embodiment, the solid-dissolvable composition has a fiber mesh with a density of less than about 0.90 g cm-3, more preferred with a density of less than about 0.85 g cm-3, and most preferred with a density of less than about 0.75 g cm-3.

In one embodiment, the solid-dissolvable composition may be in an amount between 0 wt. % and about 10 wt. %, between 1 wt. % and about 9 wt. %, between 2 wt. % and about 8 wt. %, and less than about 5 wt. % water.

In one embodiment, solid-dissolvable composition contains less than about 70 wt. % perfume capsules; in another embodiment solid-dissolvable composition contains between about 15 wt. % to about 70 wt. % perfume capsules, preferably between about 12 wt. % to about 50 wt. % perfume capsules, more preferably between about 12 wt. % to about 25 wt. % perfume capsules, most preferably between about 15 wt. % to about 20 wt. % perfume capsules.

In one embodiment, solid-dissolvable composition contains less than about 20 wt. %; in another embodiment, solid-dissolvable composition contains between about 5 wt. % and 20 wt. % neat perfume; in another embodiment solid-dissolvable composition contains less than about 15 wt. % neat perfume.

In one embodiment, solid-dissolvable composition contains less than about 20 wt. %; in another embodiment, solid-dissolvable composition contains between about 5 wt. % and 20 wt. % pro-perfume; in another embodiment solid-dissolvable composition contains less than about 15 wt. % neat pro-perfume.

In one embodiment, solid-dissolvable composition contains less than about 20 wt. %; in another embodiment, solid-dissolvable composition contains between about 5 wt. % and 20 wt. % starch encapsulates; in another embodiment solid-dissolvable composition contains less than about 15 wt. % starch encapsulates.

In one embodiment, the solid-dissolvable composition may be in a solid form such as a powder, a particle, an agglomerate, a flake, a granule, a pellet, a tablet, a lozenge, a puck, a briquette, a brick, a solid block, a unit dose, a ‘Cheetos’ shape, a ‘Hersey-kiss’ shape, or other solid form known to those of skill in the art. Herein, a ‘bead’ is a particular solid form, having a hemi-spherical shape with the preferred embodiment with a radius of between about a 1.0 mm and about 5.0 mm and mass between about 5-100 mg, with a more preferred embodiment with a radius of between about a 2.0 mm and about 4.0 mm and mass between about 5-50 mg, with the most preferred embodiment with a radius of about a 2.5 mm and mass between about 10-30 mg.

In the dissolution of the solid-dissolvable composition is greater than M_{A}>5% as determined by the DISSOLUTION TEST METHOD.

### Fabric Treatment Composition

A fabric treatment composition may comprise one or more particles of solid-dissolvable compositions added to the wash drum at the start of wash cycle to freshen fabrics. In one embodiment, the composition may contain particles of uniform composition. In another embodiment, composition may contain particles with different compositions. In a non-limiting example, one type of particle may contain perfume capsules with one wall architecture and one type of particle may contain particles with another wall architecture. In another non-limiting example, one type of particle may contain perfume capsules with one wall architecture and perfume accord and one type of particle may contain particles with the same wall architecture and a different perfume accord. In another non-limiting example, one type of particle may be one color and one type of particle may be a different color.

A fabric treatment composition may also comprise particles of solid-dissolvable compositions with different freshness agents. In one non-limiting embodiment, the composition may contain perfume capsules and neat perfume. In another non-limiting embodiment, the composition may contain perfume capsules and pro-perfume. In another non-limiting embodiment, the composition may contain perfume capsules and starch encapsulates. In another non-limiting embodiment, the composition may contain two or more particles with different blends of perfume capsules and other freshness agents.

In one embodiment, the consumer product is added directly into the wash drum, at the start of the wash; in another embodiment, the consumer product is added to the fabric enhancer cup in the washer; in another embodiment, the consumer product is added at the start of the wash; in another embodiment, the consumer product is added during the wash.

In one embodiment, the consumer product is sold in paper packaging, in one embodiment, the consumer product is sold in unit dose packaging; in one embodiment, the consumer product is sold with different colored particles; in one embodiment, the consumer product is sold in a sachet; in one embodiment, the consumer product is sold with different colored particles; in one embodiment, the consumer product is sold in a recyclable container.

In one embodiment, the solid-dissolvable composition is dispersed in matrix of polyethylene glycol (PEG).

### Preparing Solid-Dissolvable Compositions

The solid-dissolvable composition is prepared in several steps:
a) providing a perfume capsule slurry comprising perfume capsules and water, wherein the perfume capsules have a mass of perfume capsules and the water has a perfume capsule slurry water mass;
b) creating a process slurry by mixing the perfume capsule slurry with a crystallizing agent having a mass of crystallizing agent, and adding from about 0% to about 30%, by weight of the process slurry, extra water, having an extra water mass;
c) crystallizing the crystallizing agent;
d) drying to remove excess water;
e) optionally adding extra freshness benefit agent comprising a neat perfume, a pro-perfume, and/or an encapsulated starch.

### Process Slurry (a, b)

The process slurry is prepared by providing an amount of perfume capsule slurry and adding an amount of crystallizing agent. In one embodiment, the crystallizing agent is added directly in the form of sodium fatty acid carboxylate. In another embodiment, the crystallizing agent is added as fatty acid, and neutralized with sodium hydroxide. These materials and the process slurry are held at temperature greater than 45° C., above the melting point of the fatty acid and crystallization temperature for the sodium fatty acid carboxylate in these viable compositions. The temperature of the process slurry may be set to 40° C.

Viable process slurry compositions have three requirements:

First, these compositions must be flowable.

For preferred embodiments, viscosity at 0.1 s⁻¹ (low shear viscosity) is less than about 100 Pa·s, for more preferred embodiment the viscosity at 0.1 s⁻¹ is between about 0.1 Pa·s and about 30 Pa·s, for more preferred embodiment, the viscosity at 0.1 s⁻¹ between about 0.5 Pa·s and about 25 Pa·s, and for the most preferred embodiment, viscosity at 0.1 s⁻¹ between about 1 Pa·s and about 25 Pa·s, as determined by the RHEOLOGY TEST METHOD. Further, for preferred embodiments, viscosity at 100 s⁻¹ (high shear viscosity) is less than about 2 Pa·s, for more preferred embodiments, viscosity at 100 s⁻¹ between about 0.05 Pa·s and about 2 Pa·s, for more preferred embodiments, the viscosity at 100 s⁻¹ between about 0.10 Pa·s and about 1.0 Pa·s, and for the most preferred embodiments, the viscosity at 100 s⁻¹ between about 0.40 Pa·s and about 1.0 Pa·s, as determined by the RHEOLOGY TEST METHOD.

Second, the water requirement should be as small as possible. In preferred embodiments, the water requirement is less than about 2.0 kg·kg⁻¹, more preferred water requirement is less than 1.5 kg·kg⁻¹, and more preferred water requirement is less than 1.25 kg·kg⁻¹, the most preferred water requirement are less than 1.00 kg·kg⁻¹.

Third, the weight of perfume capsule is such as the solid-dissolvable composition to deliver consumer desired freshness benefits. In one embodiment, solid-dissolvable composition contains less than about 70 wt. % perfume capsules; in another embodiment solid-dissolvable composition contains between about 15 wt. % to about 70 wt. % perfume capsules, preferably between about 12 wt. % to about 50 wt. % perfume capsules, more preferably between about 12 wt. % to about 25 wt. % perfume capsules, most preferably between about 15 wt. % to about 20 wt. % perfume capsules.

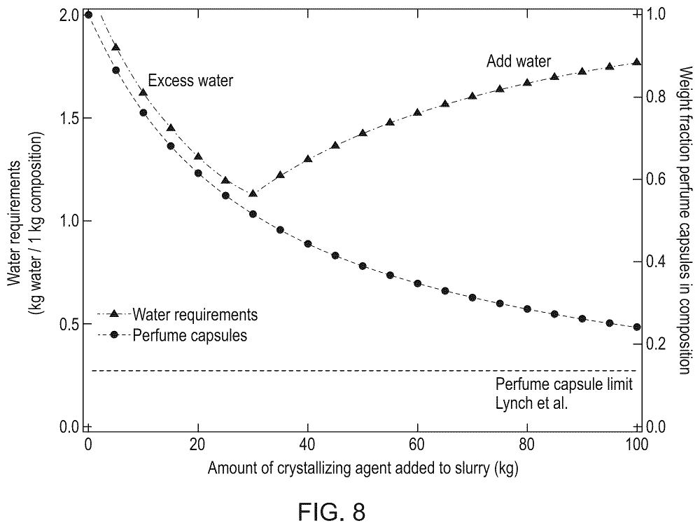

Adding water may be optionally included to ensure the process slurry meets all three requirements. For example, adding water reduces the viscosity of the process slurry. However, adding water also increases the water requirements, but may also make it possible to achieve the desired weight fraction of perfume capsules in the solid-dissolvable composition (FIG. 8).

Inventive compositions of the process slurry maintain all three requirements.

A process slurry that meets all three requirements generally comprise a range of compositions. The slurry is consider as amount of three parts by mass (M): perfume capsules (M_{pc}), crystallizing agent (M_{ca}) and water (M_{w}), where the inventors define ϕ_{pc}=M_{pc}/(M_{pc}+M_{w}) and where the inventors define ϕ_{ca}=M_{ca}/(M_{ca}+M_{w}). Not wishing to be bound by theory, it is surprising and believed that the flow property of the process slurry is dominated by the mass fraction of the perfume capsules in water or by the mass fraction of crystallizing agent in water. It is particular surprising that the flowability in these mixtures is controlled by these variables, as the mechanisms for each are completely different—the former is controlled by dispersed particle rheology and the latter is controlled by surfactant self-assembly. The ability to decouple these two rheology mechanisms to control flowability of the process slurry is unexpected. In one embodiment, the preferred range of composition is 35 wt. %>ϕ_{pc} the more preferred range of composition is 5 wt. %<ϕ_{pc}<35 wt. %, the more preferred range of composition is 10 wt. %<ϕ_{pc}<35 wt. %, and the most preferred range of composition is 15 wt. %<ϕ_{pc}<30 wt. %. In another embodiment, the preferred range of composition is 35 wt. %>ϕ_{ca}, the more preferred range of composition 10 wt. %<ϕ_{ca}<35 wt. %, the more preferred range of composition is 20 wt. %<ϕ_{ca}<35 wt. %, and the most preferred range of composition is 20 wt. %<ϕ_{ca}<30 wt. %. Not wishing to be bound by theory, it is believed that the amount of PMC in water (Wagner, Particle Rheology) and the amount of crystallizing agent in water (Laughlin, Aqueous Phase Behavior of Surfactants) result in the important rheology properties.

### Crystallization (c)

The process slurry is dispensed in the correct amounts and shapes for the final solid-dissolvable composition. In one embodiment, the preferred embodiment is dispensed with a radius of between about a 1.0 mm and about 5.0 mm and mass between about 5-100 mg, with a more preferred embodiment with a radius of between about a 2.0 mm and about 4.0 mm and mass between about 5-50 mg, with the most preferred embodiment with a radius of about a 2.5 mm and mass between about 10-30 mg.

The process slurry is crystallized by cooling the mixture below the crystallization point, either in as a single temperature step or as a series of two or more temperature steps. In one embodiment, the process slurry is prepared at 45° C. and is cooled as a single-temperature step to 5° C. in a mold in a refrigerator. In another embodiment, the process slurry is cooled as a single-temperature step to 10° C. as sheet in a refrigerator. In another embodiment, the process slurry is prepared at 55° C. cooled as a single-temperature step to 4° C. in a mold in a refrigerator.

In another embodiment, the process slurry is cooled in a two-temperature step method with a preferred embodiment is to cool the process slurry to between about 30° C.-20° C., until the process slurry reaches a steady-state (pre-crystallization) and then cool further to 5° C. to complete crystallization (final crystallization). Not wishing to be bound by theory, it is believed the first step allows pre-crystallization of the crystallizing agent to ensure fast and reproducible crystallization growth kinetics in the final step.

In a non-limiting case, the process slurry at 40° C. is passed through a scraped-wall heat exchanger, heat exchanger and static mixer to create a product stream with a steady-state amount of crystals between 30° C.-20° C. The process slurry is dispensed by a rotoformer to dispensed in the correct amounts and shapes for the final solid-dissolvable composition. The process slurry is then applied to steel belt chilled to 5° C. to achieve the final compositions.

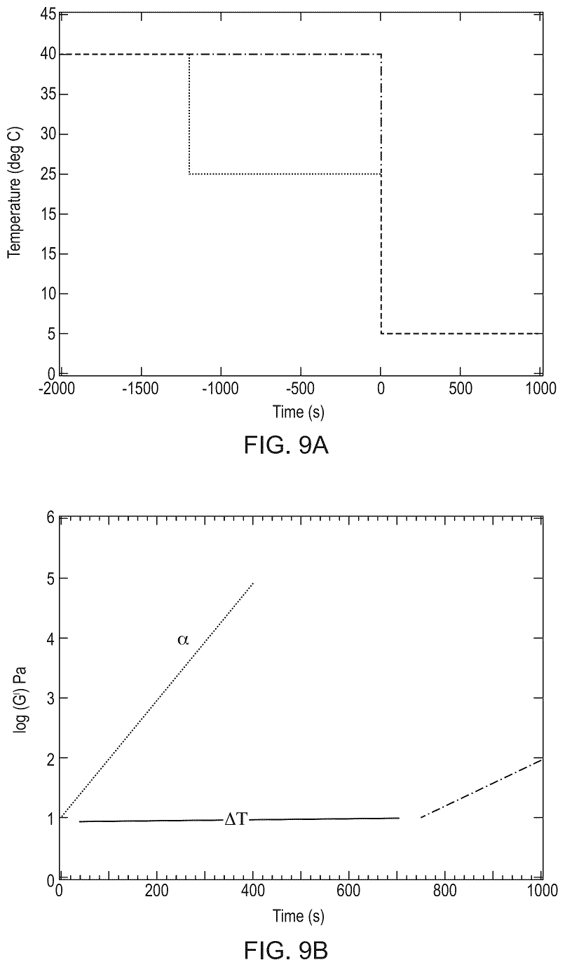

Surprisingly, the rate crystallization is high dependent on the temperature steps during processing. In one embodiment, the preferred embodiment is chill the process slurry to 30° C.-20° C. for pre-crystallization and chill the process slurry to 5° C. for final crystallization. It is most desirable for the process slurry to build fiber mesh structure as fast as possible (FIG. 9). This enables handling and drying of beads more effectively later in the process. Preferred embodiments for composition have a delay time (Δt) less than 100 seconds, more preferred embodiments have a delay time (Δt) less than 50 seconds, and the most preferred embodiments have a delay time (Δt) less than 10 seconds. Preferred embodiments reach an elastic modulus (G′) of 10³ Pa in less 300 seconds, more preferred embodiments reach the modulus in less than 75 seconds, and the most preferred embodiments reach the modulus in less than 50 seconds. An incorrect sequence of temperature steps, results in significant delays in the onset of crystallization and slower elastic modulus growth once crystallization starts, as determined by the CRYSTALLIZATION TEST METHOD.

### Drying (d)

Drying removes excess water from the process slurry to create the solid-dissolvable composition. In non-limiting examples, drying can be achieved by sun drying, hot air drying, belt drying, drum drying, contact drying, infrared drying, freeze-drying, fluidized bed drying, and dielectric drying. Drying is done while maintaining the temperature below the critical point, to prevent re-solubilization of the crystallizing agent into the process slurry.

### Optional Adds (e)

Other freshness benefits agents can be applied to or incorporated in, the solid-dissolvable composition. In one non-limiting example, neat perfume and/or pro-perfume are sprayed on the solid-dissolvable composition. In another non-limiting example, starch encapsulate is sprayed on the solid-dissolvable composition.

### Test Methods

### Dissolution Test Method

All samples and procedures are maintained at room temperature (25°+3° C.) prior to testing and are placed in a desiccant chamber (0% RH) for 24 hours, or until they come to a constant weight.

All dissolution measurements are done at a controlled temperature and a constant stir rate. A 600-mL jacketed beaker (Cole-Palmer, item #UX-03773-30, or equivalent) is attached and cooled to temperature by circulation of water through the jacketed beaker using a water circulator set to a desired temperature (Fisherbrand Isotemp 4100, or equivalent). The jacketed beaker is centered on the stirring element of a VWR Multi-Position Stirrer (VWR North American, West Chester, Pa., U.S.A. Cat. No. 12621-046). 100 mL of deionized water (MODEL 18 MW, or equivalent) and stirring bar (VWR, Spinbar, Cat. No. 58947-106, or equivalent) is added to a second 150-mL beaker (VWR North American, West Chester, Pa., U.S.A. Cat. No. 58948-138, or equivalent). The second beaker is placed into the jacketed beaker. Enough Millipore water is added to the jacketed beaker to be above the level of the water in the second beaker, with great care so that the water in the jacket beaker does not mix with the water in the second beaker. The speed of the stir bar is set to 200 RPM, enough to create a gentle vortex. The temperature is set in the second beaker using the flow from the water circulator to reach 25° C. or 37° C., with relevant temperature reported in the examples. The temperature in the second beaker is measured with a thermometer before doing a dissolution experiment.

All samples were sealed in a desiccator prepared with fresh desiccant (VWR, Desiccant-Anhydrous Indicating Drierite, stock no. 23001, or equivalent) until reaching a constant weight. All tested samples have a mass less than 15 mg.

A single dissolution experiment is done by removing a single sample from the desiccator. The sample is weighed within one minute after removing it from the desiccator to measure an initial mass (M_{I}). The sample is dropped into the second beaker with stirring. The sample is allowed to dissolve for 1 minute. At the end of the minute, the sample is carefully removed from the deionized water. The sample is placed again in the desiccator until reaching a constant final mass (M_{F}). The percentage of mass loss for the sample in the single experiment is calculated as M_{L}=100*(M_{I}−M_{F})/M_{I}.

Nine additional dissolution experiments are done, by first replacing the 100 ml of water with a new charge of deionized water, adding a new sample from the desiccator for each experiment and repeating the dissolution experiment described in the previous paragraph.

The average percent of mass loss (M_{A}) for the Test is calculated as the average percent of mass loss for the ten experiments and the average standard deviation of mass loss (SD_{A}) is the standard deviation of the mean percent of mass loss for the ten experiments. When dissolution data was not measured, the value recorded is “nm”.

### Fibers Test Method

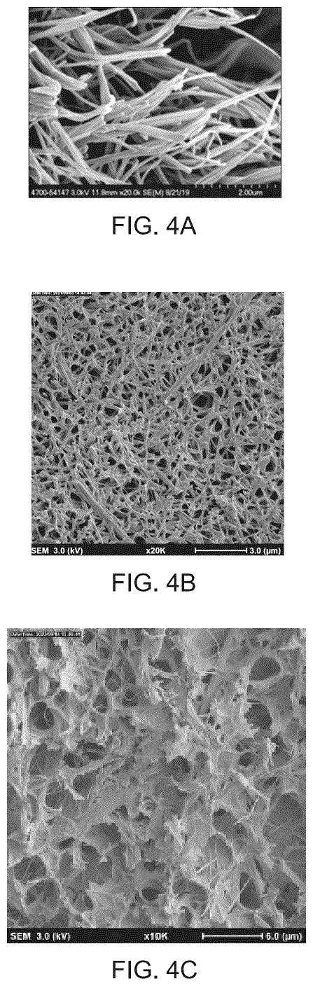

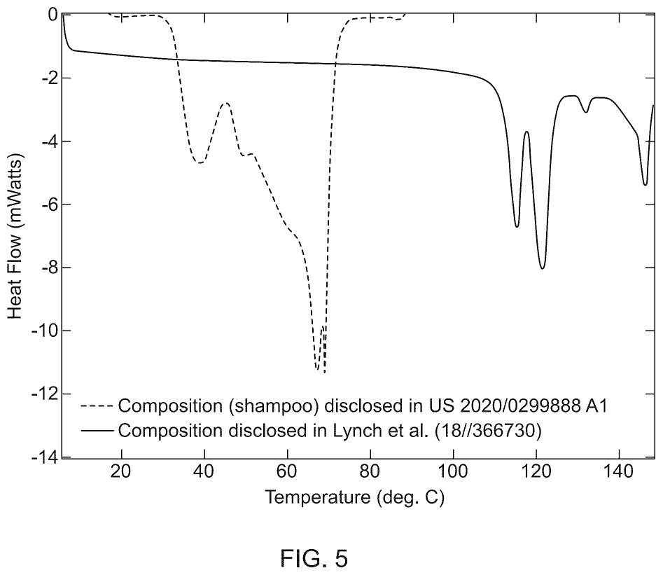

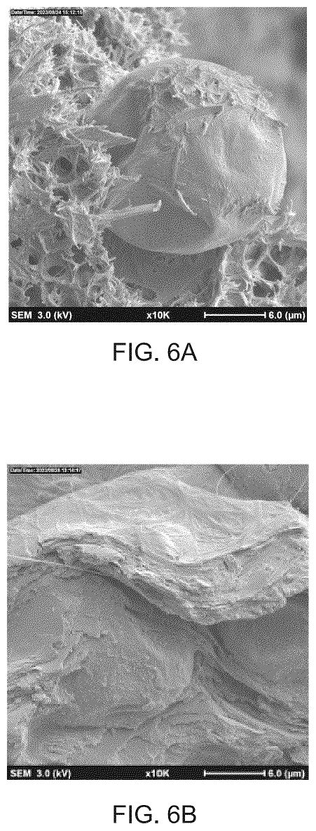

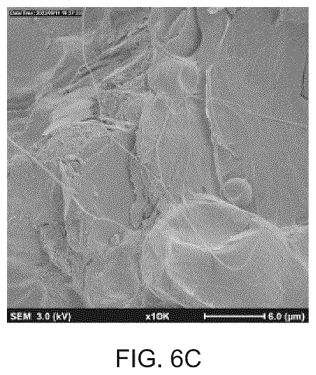

The Fiber Test Method is used to determine whether a solid dissolved composition crystallizes under process conditions and contains fiber crystals. A simple definition of a fiber is “a thread or a structure or an object resembling a thread”. Fibers have a long length in just one direction (e.g., FIG. 4). This differs from other crystal morphologies such as plates or platelets—with a long length in two or more directions (e.g., FIG. 7A and FIG. 7B). Only solid dissolved compositions with fibers are in scope of this invention.

A sample measuring about 4 mm in diameter is mounted on an SEM specimen shuttle and stub (Quorum Technologies, AL200077B and E7406) with a slit precoated comprising a 1:1 mixture of Scigen Tissue Plus optimal cutting temperature (OCT) compound (Scigen 4586) compound and colloidal graphite (agar scientific G303E). The mounted sample is plunge-frozen in a liquid nitrogen-slush bath. Next, the frozen sample is inserted a Quorum U.S. Plant Pat. No. 3,010Tcryo-prep chamber (Quorum Technologies pp 3010T), or equivalent and allowed to equilibrate to −120° C. prior to freeze-fracturing. Freeze fracturing is performed by using a cold built-in knife in the cryo-prep chamber to break off the top of the vitreous sample. Additional sublimation is performed at −90° C. for 5 mins to eliminate residual ice on the surface of the sample. The sample is cooled further to −150° C. and sputter-coated with a layer of Pt residing in the cryo-prep chamber for 60 s to mitigate charging.

High resolution imaging is performed in a Hitachi Ethos NX5000 FIB-SEM (Hitachi NX5000), or equivalent.

To determine the fiber morphology of a sample, imaging is done at 20,000× magnification. At this magnification, individual crystals of the crystallizing agent may be observed. The magnification may be slightly adjusted to lower or higher values until individual crystals are observed. One skilled in the art can assess the longest dimension of the representative crystals in the image. If this longest dimension is about 10× or greater than the other orthogonal dimensions of the crystals, these crystals are considered fibers and in scope for the invention.

### Humidity Test Method

All samples and procedures are maintained at room temperature (25°±3° C.) prior to testing.

The Humidity Test Method is used to determine the amount of water vapor sorption that occurs in a raw material or composition between being dried down at 0% RH and various RH at 25° C. In this method, 10 to 60 mg of sample are weighed, and the mass change associated with being conditioned with differing environmental states is captured in a dynamic vapor sorption instrument. The resulting mass gain is expressed as % change in mass per dried sample mass recorded at 0% RH.

This method makes use of a SPSx Vapor Sorption Analyzer with 1 ug resolution (ProUmid GmbH & Co. KG, Ulm, Germany), or equivalent dynamic vapor sorption (DVS) instrument capable of controlling percent relative humidity (% RH) to within ±3%, temperature to within ±2° C., and measuring mass to a precision of ±0.001 mg.

A 10-60 mg specimen of raw material or composition is dispersed evenly into a tared 1″ diameter Al pan. The Al pan on which raw material or composition specimen has been dispersed is placed in the DVS instrument with the DVS instrument set to 25° C. and 0% RH at which point masses are recorded ˜every 15 minutes to a precision of 0.001 mg or better. After the specimen is in the DVS for a minimum of 12 hours at this environmental setting and constant weight has been achieved, the mass m_{d} of the specimen is recorded to a precision of 0.01 mg or better. Upon completion of this step, the instrument is advanced in 10% RH increments up to 90% RH. The specimen is held in the DVS at each step for a minimum of 12 hours and until constant weight has been achieved, the mass mₙ of the specimen is recorded to a precision of 0.001 mg or better at each step.

For a particular specimen, constant weight can be defined as change in mass consecutive weighing that does not differ by more than 0.004%. For a particular specimen, % Change in mass per dried sample mass (% dm) is defined as

$$\% Change in mass per dried sample mass = \frac{{m}_{n} - {m}_{d}}{{m}_{d}} \times 100 \%$$

The % Change in mass per dried sample mass is reported in units of % to the nearest 0.01%

### Thermal Stability Test Method

All samples and procedures are maintained at room temperature (25°±3° C.) prior to testing, and at a relative humidity of 40±10% for 24 hours prior to testing.

In the Thermal Stability Test Method, differential scanning calorimetry (DSC) is performed on a 20 mg±10 mg specimen of sample composition. A simple scan is performed between 25° C. and at least 90° C., and the temperature at which the onset of the lowest-temperature peak (onset non-flat baseline) is observed to occur is reported as the Stability Temperature to the Nearest® C. For this instrumental configuration, negative values reflect adding power into the sample.

The sample is loaded into a DSC pan. All measurements are done in a high-volume-stainless-steel pan set (TA part #900825.902). The pan, lid and gasket are weighed and tared on a Mettler Toledo MT5 analytical microbalance (or equivalent; Mettler Toledo, LLC., Columbus, OH). The sample is loaded into the pan with a target weight of 20 mg (+/−10 mg) in accordance with manufacturer's specifications, taking care to ensure that the sample is in contact with the bottom of the pan. The pan is then sealed with a TA High Volume Die Set (TA part #901608.905). The final assembly is measured to obtain the sample weight. The sample is loaded into TA Q Series DSC (TA Instruments, New Castle, DE) in accordance with the manufacture instructions. The DSC procedure uses the following settings: 1) equilibrate at 25° C.; 2) mark end of cycle 1; 3) ramp 1.00° C./min to 90.00° C.; 4) mark end of cycle 3; then 5) end of method; Hit run.

### Rheology Test Method

The viscosity measurements are made with a TA Discovery HR-2 Hybrid Rheometer (TA Instruments, New Castle, Delaware, U.S.A.) and accompanying TRIOS software version 3.2.0.3877. The instrument is outfitted with a Peltier Concentric Cylinder (TA Instrument, cat. #546050.901), DIN Rotor and Standard Cup (TA Instruments, cat. #546049.901) and Split Cover (TA Instruments, cat. #545626.001). The calibration is done in accordance with manufacturer recommendations. A refrigerated, circulating water bath set to 25° C. is attached to the Concentric Cylinder. The Concentric Cylinder temperature is set to 25° C. The temperature is monitored within the Control Panel until the instrument reaches the set temperature, then an additional 5 minutes is allowed to elapse to ensure equilibration before loading sample material into the DIN Rotor.

The parameters for the DIN Rotor and Standard Cup are as follows: the inside cup diameter is 29.91 mm; the rotor diameter is 27.98 mm; the rotor length is 41.9 mm; the operating gap is 5,912.87 μm; the loading gap is 90,000.0 μm; the Environmental system is Peltier; and a sample volume capacity of between 20.90 mL and 23.0 mL.

To load the sample, a minimum of 21 mL of test sample is added to the DIN standard cup using a plastic 10 mL syringe. The sample is then allowed to sit for 15 minutes. Any trapped air bubbles are allowed to rise to the surface or otherwise dislodged and removed. The DIN Rotor is then lowered to the specified operating gap distance, and data are collected in accordance with the following settings and procedures.

The test sample is subjected to a series of steps conducted in precisely the order specified below, and data are collected during the steps of this series in accordance with the instrumental settings specified. All the steps specified in this series must be conducted, as specified and in the order listed herein regardless of whether the final parameter values are derived from any given step. Strict adherence to all the steps specified in the series is important since any given step may create a rheological history in the test sample, which may affect the subsequent steps and data.

### 60° C. Conditioning

The initial Conditioning Sample Step is conducted using the following instrumental settings: Environmental Control is set with a Temperature of 60° C.; Inherit Set Point is selected as Off; Soak Time is set to 0.0 s; Wait for Temperature is selected as On; Wait For Axial relaxation is selected as Off; Pre-shear Options is set with a Perform Pre-shear selected as On; Shear rate is set to 10.0 s⁻¹, the Duration is set to 10.0 s, Equilibrium is set with a Perform Equilibration selected as On; and Duration is set to 120.0 s.

### 60° C. Flow Sweep

The Flow Sweep Step is conducted using the following instrument settings: Environmental Control is set with a Temperature of 60° C.; Inherit Set Point is selected as Off; Soak Time is set to 180.0 s; Wait For Temperature is selected as On; Test Parameters is set with Logarithmic Sweep selected; Shear Rate is selected and set to 0.01 s⁻¹ to 100.0 s⁻¹; Points Per Decade is set to 5; Steady State Sensing is selected as Off; Equilibration Time is set to 5.0 s; Averaging time is set to 30.0 s; Scaled Time Average is selected as Off; Controlled Rate Advanced is set with Motor Mode selected as Auto; Data Acquisition is set with Save Image is selected as Off; Step Termination is set with Limit Checking Enabled selected as Off; Equilibrium Enabled is selected as Off.

### 50° C. Conditioning

The initial Conditioning Sample Step is conducted using the following instrumental settings: Environmental Control is set with a Temperature of 50° C.; Inherit Set Point is selected as Off; Soak Time is set to 0.0 s; Wait for Temperature is selected as On; Wait For Axial relaxation is selected as Off; Pre-shear Options is set with a Perform Pre-shear selected as On; Shear rate is set to 10.0 s⁻¹, the Duration is set to 10.0 s, Equilibrium is set with a Perform Equilibration selected as On; and Duration is set to 120.0 s.

### 50° C. Flow Sweep

The Flow Sweep Step is conducted using the following instrument settings: Environmental Control is set with a Temperature of 50° C.; Inherit Set Point is selected as Off; Soak Time is set to 180.0 s; Wait For Temperature is selected as On; Test Parameters is set with Logarithmic Sweep selected; Shear Rate is selected and set to 0.01 s⁻¹ to 100.0 s⁻¹; Points Per Decade is set to 5; Steady State Sensing is selected as Off; Equilibration Time is set to 5.0 s; Averaging time is set to 30.0 s; Scaled Time Average is selected as Off; Controlled Rate Advanced is set with Motor Mode selected as Auto; Data Acquisition is set with Save Image is selected as Off; Step Termination is set with Limit Checking Enabled selected as Off; Equilibrium Enabled is selected as Off.

### 40° C. Conditioning

The initial Conditioning Sample Step is conducted using the following instrumental settings: Environmental Control is set with a Temperature of 40° C.; Inherit Set Point is selected as Off; Soak Time is set to 0.0 s; Wait for Temperature is selected as On; Wait For Axial relaxation is selected as Off; Pre-shear Options is set with a Perform Pre-shear selected as On; Shear rate is set to 10.0 s⁻¹, the Duration is set to 10.0 s, Equilibrium is set with a Perform Equilibration selected as On; and Duration is set to 120.0 s.

### 40° C. Flow Sweep

The Flow Sweep Step is conducted using the following instrument settings: Environmental Control is set with a Temperature of 40° C.; Inherit Set Point is selected as Off; Soak Time is set to 180.0 s; Wait For Temperature is selected as On; Test Parameters is set with Logarithmic Sweep selected; Shear Rate is selected and set to 0.01 s⁻¹ to 100.0 s⁻¹; Points Per Decade is set to 5; Steady State Sensing is selected as Off; Equilibration Time is set to 5.0 s; Averaging time is set to 30.0 s; Scaled Time Average is selected as Off; Controlled Rate Advanced is set with Motor Mode selected as Auto; Data Acquisition is set with Save Image is selected as Off; Step Termination is set with Limit Checking Enabled selected as Off; Equilibrium Enabled is selected as Off.

### 30° C. Conditioning

The initial Conditioning Sample Step is conducted using the following instrumental settings: Environmental Control is set with a Temperature of 30° C.; Inherit Set Point is selected as Off; Soak Time is set to 0.0 s; Wait for Temperature is selected as On; Wait For Axial relaxation is selected as Off; Pre-shear Options is set with a Perform Pre-shear selected as On; Shear rate is set to 10.0 s⁻¹, the Duration is set to 10.0 s, Equilibrium is set with a Perform Equilibration selected as On; and Duration is set to 120.0 s.

### 30° C. Flow Sweep

The Flow Sweep Step is conducted using the following instrument settings: Environmental Control is set with a Temperature of 30° C.; Inherit Set Point is selected as Off; Soak Time is set to 180.0 s; Wait For Temperature is selected as On; Test Parameters is set with Logarithmic Sweep selected; Shear Rate is selected and set to 0.01 s⁻¹ to 100.0 s⁻¹; Points Per Decade is set to 5; Steady State Sensing is selected as Off; Equilibration Time is set to 5.0 s; Averaging time is set to 30.0 s; Scaled Time Average is selected as Off; Controlled Rate Advanced is set with Motor Mode selected as Auto; Data Acquisition is set with Save Image is selected as Off; Step Termination is set with Limit Checking Enabled selected as Off; Equilibrium Enabled is selected as Off.

### 20° C. Conditioning

The initial Conditioning Sample Step is conducted using the following instrumental settings: Environmental Control is set with a Temperature of 20° C.; Inherit Set Point is selected as Off; Soak Time is set to 0.0 s; Wait for Temperature is selected as On; Wait For Axial relaxation is selected as Off; Pre-shear Options is set with a Perform Pre-shear selected as On; Shear rate is set to 10.0 s⁻¹, the Duration is set to 10.0 s, Equilibrium is set with a Perform Equilibration selected as On; and Duration is set to 120.0 s.

### 20° C. Flow Sweep

The Flow Sweep Step is conducted using the following instrument settings: Environmental Control is set with a Temperature of 20° C.; Inherit Set Point is selected as Off; Soak Time is set to 180.0 s; Wait For Temperature is selected as On; Test Parameters is set with Logarithmic Sweep selected; Shear Rate is selected and set to 0.01 s⁻¹ to 100.0 s⁻¹; Points Per Decade is set to 5; Steady State Sensing is selected as Off; Equilibration Time is set to 5.0 s; Averaging time is set to 30.0 s; Scaled Time Average is selected as Off; Controlled Rate Advanced is set with Motor Mode selected as Auto; Data Acquisition is set with Save Image is selected as Off; Step Termination is set with Limit Checking Enabled selected as Off; Equilibrium Enabled is selected as Off.

The Conditioning End of Test Step is conducted using the following instrument settings: Set Temperature is selected as Off; Set Temperature System Idle (only if axial force control is active) is selected as On.

The Viscosity value is calculated from the data collected during the 40° C. Flow Sweep Step. Any data points acquired with an applied rotor torque of less than 1 uN·m are discarded; any data points acquired with a strain of less than 300% are also discarded. The remaining data points are plotted as log (shear rate) expressed in units of s⁻¹ on the x-axis and log (viscosity) expressed in units of Pa·s on the y-axis. The best-fit straight line is drawn through the last five points of the plot (i.e., the five data points obtained at the five highest shear rates).

Data are included in the example tables, with the following values: the low shear viscosity enters the viscosity at 0.1 s⁻¹ determined at 40° C. (i.e., Viscosity (0.1 s⁻¹)) as determined above; the high shear viscosity enters the viscosity at 100 s⁻¹ determined at 40° C. (i.e., Viscosity (100 s⁻¹)) as determined above; enter a value ‘Too Thick’ for compositions that could not be effectively mixed with an overhead stirrer and/or loaded effectively in the rheometer, observed as the viscosity at measured shear rate is greater than about 100 Pa·s. Examples for which a viscosity was not measured, enter a value of “nm”.

### Modulus Test Method

Measurements for the determination of the Crystallization Viscosity are made with a TA Discovery HR-2 Hybrid Rheometer (TA Instruments, New Castle, Delaware, U.S.A.) and accompanying TRIOS software version 3.2.0.3877. The instrument is outfitted with a 60 mm stainless steel Parallel Plate (TA Instrument, cat. #511600.905), Peltier Plate (TA Instruments, cat. #533230.901), and Solvent Trap Cover (TA Instruments, cat. #511400.901). The calibration is done in accordance with manufacturer recommendations. A refrigerated, circulating water bath set to 25° C. is attached to the Peltier Plate. The Peltier Plate temperature is set to 40° C. The temperature is monitored within the Control Panel until the instrument reaches the set temperature, then an additional 5 minutes is allowed to elapse to ensure equilibration before loading sample material onto the Peltier Plate.

To load the sample, a minimum of 1.9635 mL (as prescribed by the manufacturer) of test sample is added to the center surface of the Peltier plate using a 3 mL syringe. The sample is then allowed to sit for 5 minutes. Any trapped air bubbles are allowed to rise to the surface or otherwise dislodged and removed. If bubbles still remain, then the sample is removed from the Plate, the plate is cleaned with isopropanol wipe and the solvent is allowed to evaporate away. The sample loading procedure is then attempted again and repeated until a sample is loaded successfully without containing visible bubbles.

The test sample is subjected to a series of steps conducted in precisely the order specified below, and data are collected during the steps of this series in accordance with the instrumental settings specified. All of the steps specified in this series must be conducted, as specified and in the order listed herein regardless of whether or not the final parameter values are derived from any given step. Strict adherence to all the steps specified in their series is important since any given step may create a rheological history in the test sample, which may affect the subsequent steps and data.

### 40° C. Flow Peak Hold

The initial Flow Peak Hold Step is conducted using the following instrument settings: Environmental Control is set with a Temperature of 40° C.; Inherit Set Point is selected as Off; Soak Time is set to 0.0 s; Wait for Temperature is selected as On; Test Parameters is set with a Duration of 1200.0 s; Shear Rate is selected and set to 1.0 s⁻¹; Inherit initial value is selected as Off; Sampling interval is selected and set to 1.0 s/pt; Controlled Rate Advanced is set with a Motor mode selected as Auto; Data acquisition is set with a End of step selected as Zero torque; Fast sampling is selected as Off; Save image is selected as Off; Step Termination is set with Limit checking Enabled selected as Off; Equilibrium Enabled is selected as Off.

### 40° C. or 25° C.—Flow Peak Hold

The second Flow Peak Hold Step is conducted using the following instrument settings: Environmental Control is set with a Temperature of either 40° C. or 25° C.; Inherit Set Point is selected as Off; Soak Time is set to 0.0 s; Wait for Temperature is selected as On; Test Parameters is set with a Duration of 1200.0 s; Shear Rate is selected and set to 1.0 s⁻¹; Inherit initial value is selected as Off; Sampling interval is selected and set to 1.0 s/pt; Controlled Rate Advanced is set with a Motor mode selected as Auto; Data acquisition is set with a End of step selected as Zero torque; Fast sampling is selected as Off; Save image is selected as Off; Step Termination is set with Limit checking Enabled selected as Off; Equilibrium Enabled is selected as Off.

### 5° C. Oscillation Time

The third Oscillation Time Step is conducted using the following instrumental settings: Environmental Control is set with a Temperature of 5° C.; Inherit Set Point is selected as Off; Soak Time is set to 0.0 s; Wait For Temperature is selected as Off; Test Parameters is set with Duration set to 2400.0 s; Sampling interval is set to 1.0 s/pt; Strain % is set to 1.0%; Single Point is selected; Frequency is set to 1.0 Hz; Controlled Strain Advanced is set to Continuous oscillation [direct strain]; Moto mode is selected to Auto; Data acquisition is set with Acquisition Mode Correlation selected as On, Transient is selected as Off; Conditioning time is selected as Time and is set to 3.0 s; Sampling time is selected as Time and is set to 3.0 s; Save waveform (point display) is selected as On; Number of points in waveform is set to 64; Save image is selected as Off; Use additional harmonics is selected as Off; Step Termination is set with Limit checking Enabled selected as Off; Equilibrium Enabled is selected as Off.

The final Conditioning End of Test Step is conducted using the following instrument settings: Set Temperature is selected as 25° C.; Set Temperature System Idle (only if axial force control is active) is selected as Off.

The Crystallization Viscosity value is calculated from the data collected during the 5° C. Oscillation Time Step. The data is plotted with Step Time(s) on the x-axis and the log of the Storage Modulus (G′ Pa) plotted on the y-axis (FIG. 9B). The x-axis is then scaled from 0 s to 500 s.

The Method returns the delay time ‘ΔT’ which is the difference in the time at which the temperature is set to 5° C. and when the modulus begins to grow. The Method returns the delay time ‘ΔT’ which is the difference in the time at which the temperature is set to 5° C. and when the modulus begins to grow; the Method returns the ‘Time (G′1000)’, which is the time at which modulus starts to grow and reaches 1000 Pa.

### EXAMPLES

Each inventive sample shows a solid-dissolvable composition with very high level (12 or 20 wt. % to about 70 wt. %) perfume capsules with acceptable water requirements, prepared with the inventive method of making to ensure adequate processability of the process slurry.

EXAMPLE 1 shows inventive solid-dissolvable compositions prepared by the inventive, single-temperature process, in which fatty acid materials are added directly to the perfume capsule slurry, neutralized by the addition of sodium hydroxide, crystallized in a step, and dried to create the solid-dissolvable compositions with high levels of perfume microcapsules with acceptable water requirements.

EXAMPLE 2 shows inventive solid-dissolvable compositions prepared by the inventive, single-temperature process, in which sodium decanoate is added directly to the perfume capsule slurry, crystallized in a single-temperature step, and dried to create the solid-dissolvable compositions with high levels of perfume microcapsules with acceptable water requirements.

EXAMPLE 3 shows inventive solid-dissolvable compositions prepared by the inventive, single-temperature process, in which blends of sodium octanoate, sodium decanoate, are sodium dodecanoate are added directly to the perfume capsule slurry, crystallized in a single-temperature step, and dried to create the solid-dissolvable compositions with high levels of perfume microcapsules with acceptable water requirements.

EXAMPLE 4 shows comparative example in which compositions prepared with sodium tetradecanoate, sodium hexadecanoate and sodium octadecanoate, which cannot be processed.

The process slurry for these compositions are too viscous to be processed, and unsuitable for this invention.

EXAMPLE 5 shows inventive solid-dissolvable compositions prepared by the inventive, single-temperature process in which blends of sodium octanoate, sodium decanoate, are sodium dodecanoate are added directly to the perfume capsule slurry, crystallized in a single-temperature step, and dried to create the solid-dissolvable compositions with high levels of perfume microcapsules with acceptable water requirements.

EXAMPLE 6 shows inventive solid-dissolvable compositions prepared by the inventive, two-temperature process in which blends of sodium octanoate, sodium decanoate, are sodium dodecanoate are added directly to the perfume capsule slurry, crystallized in a two-temperature step, and dried to create the solid-dissolvable compositions with high levels of perfume microcapsules with acceptable water requirements. In this example, the two-temperature process is optimized to ensure fast and substantial crystallization of the crystallizing agent.

All EXAMPLES, optionally adding extra freshness benefit agent neat perfume, pro-perfume, and/or encapsulated starch.

The data table in the examples show:

### Process Slurry (Top Section)

Provides all the materials and amounts, and includes ϕ_{PC}, ϕ_{CA}, Water Requirement, Viscosity (0.1 s⁻¹), Viscosity (100 s⁻¹), associated with the composition of the process slurry.

### Solid-Dissolvable Composition (Middle Section)

Provides all the materials and amounts of the solid-dissolvable composition prepared from drying the process slurry, including the levels of the perfume capsules in the composition.

### Dissolution (Bottom Section)

Performance measure on the solid-dissolvable composition, ‘M_{S}’, ‘T’ and ‘M_{A}’ are outputs of the DISSOLUTION TEST METHOD (Example 1-Example 5); performance measure on crystallization ‘ΔT’ and Time (G′₁₀₀₀) are outputs of the MODULUS TEST METHOD (Example 6).

### Materials

(1) Water: Millipore, Burlington, MA (18 m-ohm resistance)
(2) Sodium caprylic (sodium octanoate, NaC8): TCI Chemicals, Cat #00034
(3) Sodium caprate (sodium decanoate, NaCl0): TCI Chemicals, Cat #D0024
(4) Sodium laurate (sodium dodecanoate, NaCl2): TCI Chemicals, Cat #L0016
(5) Sodium myristate (sodium tetradecanoate, NaCl4): TCI Chemicals, Cat. #M0483
(6) Sodium palmitate (sodium hexadecanoate, NaCl6): TCI Chemicals, Cat. #P00007
(7) Sodium stearate (sodium octadecanoate, NaCl8): TCI Chemicals, Cat. #S0031
(8) Perfume capsule slurry: Milliken, Encapsulated Perfume #1, melamine formealdehydepol wall chemistry, (31% activity)
(9) Neat perfume: International Flavors and Fragrances, Neat Perfume Oil #1
(10) Sodium chloride: VWR BDH Chemical, Cat. no. BDH9286-500 g
(11) Fatty Acid Blend: C810L, Procter & Gamble Chemicals
(12) Lauric Acid: Peter Cremer, Cat. #FA-1299 Lauric Acid
(13) Sodium Hydroxide (50 wt. % solution): Fisher Scientific, Cat. #SS254-4
(14) Perfume Capsule Slurry: Milliken, Encapsulated Perfume #3 Polyacrylate wall chemistry, 21 wt. % active
(15) Perfume Capsule Slurry: Encapsulated Perfume #4, High Core to Wall ratio, 21 wt. % active
(16) Perfume Capsule Slurry: Encapsulated Perfume #5, Polyurea wall chemistry, 32 wt. % active
(17) Perfume Capsule Slurry: Encapsulated Perfume #6, silica based wall chemistry, 6.2 wt. % active

### Example 1

EXAMPLE 1 shows inventive solid-dissolvable compositions prepared by the inventive, single-temperature process, in which fatty acid materials are added directly to the perfume capsule slurry, neutralized by the addition of sodium hydroxide, crystallized in a step, and dried to create the solid-dissolvable compositions with high levels of perfume microcapsules with acceptable water requirements.

Sample AA-Sample AE contain more than 30 wt. % crystallizing agent if there is no extra water making them difficult to process due to thickening. Extra water is added to ensure f_{CA} remains less than about 35 wt. % to ensure flowable process slurry. The water requirement is reduced by adding less water with an increase in perfume capsules levels in the solid-dissolvable composition.

Sample AF minimizes extra water while ensuring ϕ_{CA} remains about 35 wt. % to ensure flowable process slurry and resulting in 35 wt. % perfume capsules in the solid-dissolvable composition.

Sample AG-Sample AL contain less than ϕ_{PC}<35 wt. %, to ensure flowability of the process slurry and while further increasing the loading of perfume capsules in the solid-dissolvable composition, all possible while maintaining water requirements below about 2.0.

All these inventive compositions have acceptable dissolution as measured by the DISSOLUTION TEST METHOD.

### Process Slurry

A 250-ml stainless steel beaker (Thermo Fischer Scientific, Waltham, MA.) was placed on a hot plate (VWR, Radnor, PA, 7×7 CER Hotplate, cat. no. NO97042-690). Perfume capsule slurry and then fatty acids were added to the beaker, as well as Water (Milli-Q Academic), if needed. A temperature probe was placed into composition. A mixing device comprising an overhead mixer (IKA Works Inc, Wilmington, NC, model RW20 DMZ) and a three-blade impeller design was assembled, with the impeller placed into the composition. The heater was set at 55° C., the impeller was set to rotate at 250 rpm and the composition was heated to 55° C. until all fatty acids were emulsified. Once the composition had reached homogeneity, aqueous sodium hydroxide was added to the beaker in a dropwise fashion. The resulting composition was kept under the mixing conditions until homogeneity was reached again and no large particulates could be seen in the beaker.

### Crystallizing

The composition was transferred to polymer mold containing a pattern of 5 mm diameter hemispheres, evenly dispersed using a rubber baking spatula, and excess material was scraped from the top of the mold. The mold was placed in a refrigerator (VWR Door Solid Lock F Refrigerator 115V, 76300-508, or equivalent) equilibrated to 4° C. for 24 hours allowing the crystallizing agent to crystallize, as a single-temperature step.

### Drying

The molds were placed in a convection oven (Yamato, DKN400, or equivalent) set to 25° C. with air circulating for another 24 hours. The beads were then removed from the mold and collected.

TABLE 1

| | Sample AA | | Sample AB | | Sample AC | | Sample AD | |
|---|---|---|---|---|---|---|---|---|
| | inventive | | inventive | | inventive | | inventive | |
| Process Slurry | | | | | | | | |
| (8) PMC Slurry | 14.81 | g | 24.19 | g | 32.26 | g | 41.48 | g |
| (11) Fatty Acid | 10.51 | g | 10.51 | g | 10.51 | g | 10.51 | g |
| Blend: C810L | | | | | | | | |
| (12) Lauric Acid | 16.22 | g | 16.22 | g | 16.22 | g | 16.22 | g |
| (13) 50 wt. % NaOH | 11.89 | g | 11.89 | g | 11.89 | g | 11.89 | g |
| (1) Water | 46.57 | g | 37.18 | g | 29.12 | g | 19.89 | g |
| ϕ_{PC} | 6.55 | wt. % | 10.69 | wt. % | 14.26 | wt. % | 18.3 | wt. % |
| ϕ_{CA} | 31.38 | wt. % | 32.37 | wt. % | 33.26 | wt. % | 34.0 | wt. % |
| Water Requirement | 1.896 | kg · kg⁻¹ | 1.671 | kg · kg⁻¹ | 1.504 | kg · kg⁻¹ | 1.196 | kg · kg⁻¹ |
| Viscosity (0.1 s⁻¹) | 0.102 | Pa · s | 0.512 | Pa · s | 1.242 | Pa · s | 1.380 | Pa · s |
| Viscosity (100 s⁻¹) | 0.042 | Pa · s | 0.066 | Pa · s | 0.123 | Pa · s | 0.303 | Pa · s |
| Solid-Dissolvable | | | | | | | | |
| Composition | | | | | | | | |
| NaC8 | 19.82 | wt. % | 18.28 | wt. % | 17.14 | wt. % | 18.34 | wt. % |
| NaC10 | 14.81 | wt. % | 13.66 | wt. % | 12.81 | wt. % | 11.95 | wt. % |
| NaC12 | 52.08 | wt. % | 48.04 | wt. % | 45.04 | wt. % | 42.03 | wt. % |
| % PMC (dry) | 13.28 | wt. % | 20.01 | wt. % | 25.02 | wt. % | 30.03 | wt. % |
| Dissolution | | | | | | | | |
| Mₛ | 14.0 | mg | 16.8 | mg | 17.2 | mg | 14.3 | mg |
| T | 25° | C. | 25° | C. | 25° | C. | 25° | C. |

| | | | | |
|---|---|---|---|---|
| M_{A} | 15.9% | 12.9% | 13.5% | 13.8% |

TABLE 2

| | Sample AE | | Sample AF | | Sample AG | | Sample AH | |
|---|---|---|---|---|---|---|---|---|
| | inventive | | inventive | | inventive | | inventive | |
| Process Slurry | | | | | | | | |
| (8) PMC Slurry | 52.10 | g | 64.52 | g | 79.19 | g | 96.77 | g |
| (11) Fatty Acid | 10.51 | g | 10.51 | g | 10.51 | g | 10.51 | g |
| Blend: C810L | | | | | | | | |
| (12) Lauric Acid | 16.22 | g | 16.22 | g | 16.22 | g | 16.22 | g |
| (13) 50 wt. % NaOH | 11.89 | g | 11.89 | g | 11.89 | g | 11.89 | g |
| (1) Water | 9.28 | g | 0 | g | 0 | g | 0 | g |
| ϕ_{PC} | 23.03 | wt. % | 27.30 | wt. % | 27.92 | wt. % | 28.43 | wt. % |
| ϕ_{CA} | 35.70 | wt. % | 36.00 | wt. % | 32.10 | wt. % | 28.41 | wt. % |
| Water Requirement | 1.170 | kg · kg⁻¹ | 1.066 | kg · kg⁻¹ | 1.163 | kg · kg⁻¹ | 1.259 | kg · kg⁻¹ |
| Viscosity (0.1 s⁻¹) | 15.401 | Pa · s | 27.899 | Pa · s | 10.377 | Pa · s | 11.425 | Pa · s |
| Viscosity (100 s⁻¹) | 0.702 | Pa · s | 1.239 | Pa · s | 0.790 | Pa · s | 0.757 | Pa · s |
| Solid-Dissolvable | | | | | | | | |
| Composition | | | | | | | | |
| NaC8 | 14.85 | wt. % | 13.71 | wt. % | 12.56 | wt. % | 11.42 | wt. % |
| NaC10 | 11.10 | wt. % | 10.24 | wt. % | 9.39 | wt. % | 8.53 | wt. % |
| NaC12 | 39.03 | wt. % | 36.02 | wt. % | 33.02 | wt. % | 30.02 | wt. % |
| % PMC (dry) | 35.02 | wt. % | 40.03 | wt. % | 45.03 | wt. % | 50.03 | wt. % |
| Dissolution | | | | | | | | |
| Mₛ | 14.7 | mg | 18.4 | mg | 18.6 | mg | 15.7 | mg |
| T | 25° | C. | 25° | C. | 25° | C. | 25° | C. |
| M_{A} | 14.7 | wt. % | 13.6 | wt. % | 11.3 | wt. % | 10.6 | wt. % |

TABLE 3

| | Sample AI | | Sample AJ | | Sample AK | | Sample AL | |
|---|---|---|---|---|---|---|---|---|
| | inventive | | inventive | | inventive | | inventive | |
| Process Slurry | | | | | | | | |
| (8) PMC Slurry | 118.29 | g | 145.16 | g | 179.71 | g | 225.81 | g |
| (11) Fatty Acid | 10.51 | g | 10.51 | g | 10.51 | g | 10.51 | g |
| Blend: C810L | | | | | | | | |
| (12) Lauric Acid | 16.22 | g | 16.22 | g | 16.22 | g | 16.22 | g |
| (13) 50 wt. % NaOH | 11.89 | g | 11.89 | g | 11.89 | g | 11.89 | g |
| (1) Water | 0 | g | 0 | g | 0 | g | 0 | g |
| ϕ_{PC} | 28.87 | wt. % | 29.24 | wt. % | 29.56 | wt. % | 29.84 | wt. % |
| ϕ_{CA} | 24.90 | wt. % | 21.58 | wt. % | 18.42 | wt. % | 15.41 | wt. % |
| Water Requirement | 1.356 | kg · kg⁻¹ | 1.453 | kg · kg⁻¹ | 1.549 | kg · kg⁻¹ | 1.646 | kg · kg⁻¹ |
| Viscosity (0.1 s⁻¹) | 28.655 | Pa · s | 15.634 | Pa · s | 29.569 | Pa · s | nm | |
| Viscosity (100 s⁻¹) | 0.814 | Pa · s | 0.468 | Pa · s | 1.393 | Pa · s | nm | |
| Solid-Dissolvable | | | | | | | | |
| Composition | | | | | | | | |
| NaC8 | 10.28 | wt. % | 9.14 | wt. % | 8.00 | wt. % | 6.85 | wt. % |
| NaC10 | 7.68 | wt. % | 6.83 | wt. % | 5.97 | wt. % | 5.12 | wt. % |
| NaC12 | 27.01 | wt. % | 24.01 | wt. % | 21.01 | wt. % | 18.01 | wt. % |
| % PMC (dry) | 55.03 | wt. % | 60.03 | wt. % | 65.02 | wt. % | 70.02 | wt. % |
| Dissolution | | | | | | | | |
| Mₛ | 15.8 | mg | 16.2 | mg | 16.5 | mg | 15.0 | mg |
| T | 25° | C. | 25° | C. | 25° | C. | 25° | C. |
| M_{A} | 7.6 | wt. % | 7.9 | wt. % | 6.3 | wt. % | 5.6 | wt. % |

### Example 2

EXAMPLE 2 shows inventive solid-dissolvable compositions prepared by the inventive, single-temperature process, in which sodium decanoate is added directly to the perfume capsule slurry, crystallized in a single-temperature step, and dried to create the solid-dissolvable compositions with high levels of perfume microcapsules with acceptable water requirements.

Sample BA-Sample BB contain more contain relatively high level of perfume capsules in the process slurry such that ϕ_{PC} remains about 30 wt. % and resulting in a large Viscosity (0.1 s⁻¹), that pushes the limits of flowability for creating very high levels of perfume microcapsules in the solid-dissolvable composition and good water requirements below 2.0 kg·kg⁻¹.

Sample BD-Sample BJ reduce the level of perfume capsules in the process slurry (ϕ_{PC}) and the solid-dissolvable composition by systematically increasing added water and crystallizing agent and ensure flowability by keeping level of crystallizing agent in the process slurry (ϕ_{CA}) less than about 30 wt. %. The process creates very high levels of perfume microcapsules in the solid-dissolvable composition and good water requirements below 2.0 kg·kg⁻¹.

Sample BC shows an optimal balance of processability, high-level of perfume capsules in the solid-dissolvable composition, and minimal water requirement.

All these inventive compositions have acceptable dissolution as measured by the DISSOLUTION TEST METHOD.

### Process Slurry

A 250-ml stainless steel beaker (Thermo Fischer Scientific, Waltham, MA.) was placed on a hot plate (VWR, Radnor, PA, 7×7 CER Hotplate, cat. no. NO97042-690). Perfume capsule slurry and then fatty acids were added to the beaker, as well as Water (Milli-Q Academic), if needed. A temperature probe was placed into composition. A mixing device comprising an overhead mixer (IKA Works Inc, Wilmington, NC, model RW20 DMZ) and a three-blade impeller design was assembled, with the impeller placed into the composition. The heater was set at 55° C., the impeller was set to rotate at 250 rpm and the composition was heated to 55° C. until all the sodium fatty acid carboxylate was added and mixed until reaching homogeneity and no large particulates could be seen in the beaker.

### Crystallizing

The composition was transferred to polymer mold containing a pattern of 5 mm diameter hemispheres, evenly dispersed using a rubber baking spatula, and excess material was scraped from the top of the mold. The mold was placed in a refrigerator (VWR Door Solid Lock F Refrigerator 115V, 76300-508, or equivalent) equilibrated to 4° C. for 24 hours allowing the crystallizing agent to crystallize, as a single-temperature step.

### Drying

The molds were placed in a convection oven (Yamato, DKN400, or equivalent) set to 25° C. with air circulating for another 24 hours. The beads were then removed from the mold and collected.

TABLE 4

| | Sample BA | | Sample BB | | Sample BC | | Sample BD | |
|---|---|---|---|---|---|---|---|---|
| | inventive | | inventive | | inventive | | inventive | |
| Process Slurry | | | | | | | | |
| (8) PMC | 25.003 | g | 25.001 | g | 25.006 | g | 25.002 | |
| (2) NaC8 | — | | — | | — | | — | |
| (3) NaC10 | 2.502 | g | 5.004 | g | 7.501 | g | 10.001 | |
| (4) NaC12 | — | | — | | — | | — | |
| (1) Water | — | | — | | 0.251 | g | 6.085 | g |
| ϕ_{PC} | 31.00 | wt. % | 31.00 | wt. % | 30.69 | wt. % | 24.93 | wt. % |
| ϕ_{CA} | 12.67 | wt. % | 22.49 | wt. % | 30.00 | wt. % | 30.00 | wt. % |
| Water Requirement | 1.680 | kg · kg⁻¹ | 1.353 | kg · kg⁻¹ | 1.148 | kg · kg⁻¹ | 1.315 | kg · kg⁻¹ |
| Viscosity (0.1 s⁻¹) | 20.925 | Pa · s | 6.415 | Pa · s | 5.770 | Pa · s | 3.745 | Pa · s |
| Viscosity (100 s⁻¹) | 1.006 | Pa · s | 0.473 | Pa · s | 0.489 | Pa · s | 0.201 | Pa · s |
| Solid-Dissolvable | | | | | | | | |
| Composition | | | | | | | | |
| NaC8 | — | | — | | — | | — | |
| NaC10 | 24.40 | wt. % | 39.23 | wt. % | 49.18 | wt. % | 56.34 | wt. % |
| NaC12 | — | | — | | — | | — | |
| % PMC (dry) | 75.60 | wt. % | 60.77 | wt. % | 50.82 | wt. % | 43.66 | wt. % |
| Dissolution | | | | | | | | |

| | | | | |
|---|---|---|---|---|
| Mₛ | nm | nm | nm | nm |
| T | nm | nm | nm | nm |
| M_{A} | nm | nm | nm | nm |

TABLE 5

| | Sample BE | | Sample BF | | Sample BG | | Sample BH | |
|---|---|---|---|---|---|---|---|---|
| | inventive | | inventive | | inventive | | inventive | |
| Process Slurry | | | | | | | | |
| (8) PMC | 25.007 | | 12.509 | g | 12.509 | g | 12.500 | g |
| (2) NaC8 | — | | — | | — | | — | |
| (3) NaC10 | 12.504 | g | 7.509 | g | 8.756 | g | 10.006 | g |
| (4) NaC12 | — | | — | | — | | — | |
| (1) Water | 11.929 | g | 8.889 | g | 11.799 | g | 14.719 | g |
| ϕ_{PC} | 20.99 | wt. % | 18.00 | wt. % | 15.95 | wt. % | 14.24 | wt. % |
| ϕ_{CA} | 29.99 | wt. % | 30.17 | wt. % | 30.00 | wt. % | 30.00 | wt. % |
| Water Requirement | 1.441 | kg · kg⁻¹ | 1.535 | kg · kg⁻¹ | 1.617 | kg · kg⁻¹ | 1.682 | kg · kg⁻¹ |
| Viscosity (0.1 s⁻¹) | 2.465 | Pa · s | 1.100 | Pa · s | 85.178 | Pa · s | 0.752 | Pa · s |
| Viscosity (100 s⁻¹) | 0.124 | Pa · s | 0.079 | Pa · s | 0.058 | Pa · s | 0.050 | Pa · s |
| Solid-Dissolvable | | | | | | | | |
| Composition | | | | | | | | |
| NaC8 | — | | — | | | | — | |
| NaC10 | 76.33 | wt. % | 66.31 | wt. % | 69.85 | wt. % | 72.08 | wt. % |
| NaC12 | — | | — | | | | — | |
| % PMC (dry) | 23.67 | wt. % | 33.69 | wt. % | 33.35 | wt. % | 27.92 | wt. % |
| Dissolution | | | | | | | | |

| | | | | |
|---|---|---|---|---|
| Mₛ | nm | nm | nm | nm |
| T | nm | nm | nm | nm |
| M_{A} | nm | nm | nm | nm |

TABLE 6

| | |
|---|---|
| Sample BI inventive | Sample BJ inventive |

Process Slurry

| | | | | |
|---|---|---|---|---|
| (8) PMC | 12.509 | g | 12.502 | g |

| | | |
|---|---|---|
| (2) NaC8 | — | — |

| | | | |
|---|---|---|---|
| (3) NaC10 | 11.259 | g | 12.508 |

| | | |
|---|---|---|
| (4) NaC12 | — | — |

| (1) Water | 17.639 | g | 20.548 | |
|---|---|---|---|---|
| ϕ_{PC} | 12.86 | wt. % | 11.73 | wt. % |
| ϕ_{CA} | 30.00 | wt. % | 30.01 | wt. % |
| Water Requirement | 1.736 | kg · kg⁻¹ | 1.781 | kg · kg⁻¹ |
| Viscosity (0.1 s⁻¹) | 0.514 | Pa · s | 0.194 | Pa · s |
| Viscosity (100 s⁻¹) | 0.031 | Pa · s | 0.029 | Pa · s |

| | | |
|---|---|---|
| Solid-Dissolvable | | |
| Composition | | |
| NaC8 | — | — |

| | | | | |
|---|---|---|---|---|
| NaC10 | 74.38 | wt. % | 76.34 | wt. % |

| | | |
|---|---|---|
| NaC12 | — | — |

| | | | | |
|---|---|---|---|---|
| % PMC (dry) | 25.62 | wt. % | 23.66 | wt. % |

| | | |
|---|---|---|
| Dissolution | | |
| Mₛ | nm | nm |
| T | nm | nm |
| M_{A} | nm | nm |

### Example 3

EXAMPLE 3 shows inventive solid-dissolvable compositions prepared by the inventive, single-temperature process, in which blends of sodium octanoate, sodium decanoate, are sodium dodecanoate are added directly to the perfume capsule slurry, crystallized in a single-temperature step, and dried to create the solid-dissolvable compositions with high levels of perfume microcapsules with acceptable water requirements.

Sample CA-Sample CL are pivot examples in which solid-dissolvable compositions with very high levels of perfume capsules (i.e., 50 wt. %) can be achieved with sodium octanoate, sodium decanoate and sodium dodecanoate and mixtures thereof, with high concentrations of perfume capsules (about f_{PC}=30 wt. %) and crystallizing agent (about f_{CA}=30 wt. %) in the process slurry and enabling very low water requirements (1.113 kg·kg⁻¹). Not wishing to be bound by theory, the flowability of the process slurry among these examples results from the relative short chain length (small hydrophobicity) of the crystallizing agent. These compositions are also dissolvable where the rate is adjusted by the selection of the crystallizing agent (e.g., in comparison of Sample CA, Sample CB and Sample CC).

All these inventive compositions have acceptable dissolution as measured by the DISSOLUTION TEST METHOD.

### Process Slurry

A 250-ml stainless steel beaker (Thermo Fischer Scientific, Waltham, MA.) was placed on a hot plate (VWR, Radnor, PA, 7×7 CER Hotplate, cat. no. NO97042-690). Perfume capsule slurry and then fatty acids were added to the beaker, as well as Water (Milli-Q Academic), if needed. A temperature probe was placed into composition. A mixing device comprising an overhead mixer (IKA Works Inc, Wilmington, NC, model RW20 DMZ) and a three-blade impeller design was assembled, with the impeller placed into the composition. The heater was set at 55° C., the impeller was set to rotate at 250 rpm and the composition was heated to 55° C. until all the sodium fatty acid carboxylate was added and mixed until reaching homogeneity and no large particulates could be seen in the beaker.

### Crystallizing

The composition was transferred to polymer mold containing a pattern of 5 mm diameter hemispheres, evenly dispersed using a rubber baking spatula, and excess material was scraped from the top of the mold. The mold was placed in a refrigerator (VWR Door Solid Lock F Refrigerator 115V, 76300-508, or equivalent) equilibrated to 4° C. for 24 hours allowing the crystallizing agent to crystallize, as a single-temperature step.

### Drying

The molds were placed in a convection oven (Yamato, DKN400, or equivalent) set to 25° C. with air circulating for another 24 hours. The beads were then removed from the mold and collected.

TABLE 7

| | Sample CA | | Sample CB | | Sample CC | | Sample CD | |
|---|---|---|---|---|---|---|---|---|
| | inventive | | inventive | | inventive | | inventive | |
| Process Slurry | | | | | | | | |
| (8) PMC | 100.00 | g | 100.00 | g | 100.00 | g | 38.17 | g |
| (2) NaC8 | 31.00 | g | — | | — | | 2.37 | g |
| (3) NaC10 | — | | 31.00 | g | — | | — | |
| (4) NaC12 | — | | — | | 31.00 | g | 9.47 | g |
| (1) Water | — | | — | | — | | — | |
| ϕ_{PC} | 31.00 | wt. % | 31.00 | wt. % | 31.00 | wt. % | 31.00 | wt. % |
| ϕ_{CA} | 31.00 | wt. % | 31.00 | wt. % | 31.00 | wt. % | 31.00 | wt. % |
| Water Requirement | 1.113 | kg · kg⁻¹ | 1.113 | kg · kg⁻¹ | 1.113 | kg · kg⁻¹ | 1.113 | kg · kg⁻¹ |
| Viscosity (0.1 s⁻¹) | nm | | nm | | nm | | nm | |
| Viscosity (100 s⁻¹) | nm | | nm | | nm | | nm | |
| Solid-Dissolvable | | | | | | | | |
| Composition | | | | | | | | |
| NaC8 | 50 | wt. % | — | | — | | 10 | wt. % |
| NaC10 | — | | 50 | wt. % | — | | — | |
| NaC12 | — | | — | | 50 | wt. % | 40 | wt. % |
| % PMC (dry) | 50 | wt. % | 50 | wt. % | 50 | wt. % | 50 | wt. % |
| Dissolution | | | | | | | | |
| Mₛ | 17.8 | mg | 15.5 | mg | 15.4 | mg | 13.9 | mg |
| T | 25° | C. | 25° | C. | 25° | C. | 25° | C. |
| M_{A} | 11.8 | wt. % | 9.69 | wt. % | 5.24 | wt. % | 5.87 | wt. % |

TABLE 8

| | Sample CE | | Sample CF | | Sample CG | | Sample CH | |
|---|---|---|---|---|---|---|---|---|
| | inventive | | inventive | | inventive | | inventive | |
| Process Slurry | | | | | | | | |
| (8) PMC | 38.17 | g | 38.17 | g | 38.17 | g | 38.17 | g |
| (2) NaC8 | — | | 5.92 | g | 5.92 | g | — | |
| (3) NaC10 | 2.37 | g | 5.92 | g | — | | 5.92 | g |
| (4) NaC12 | 9.47 | g | — | | 5.92 | g | 5.92 | g |
| (1) Water | — | | — | | — | | — | |
| ϕ_{PC} | 31.00 | wt. % | 31.00 | wt. % | 31.00 | wt. % | 31.00 | wt. % |
| ϕ_{CA} | 31.00 | wt. % | 31.00 | wt. % | 31.00 | wt. % | 31.00 | wt. % |
| Water Requirement | 1.113 | kg · kg⁻¹ | 1.113 | kg · kg⁻¹ | 1.113 | kg · kg⁻¹ | 1.113 | kg · kg⁻¹ |
| Viscosity (0.1 s⁻¹) | nm | | nm | | nm | | nm | |
| Viscosity (100 s⁻¹) | nm | | nm | | nm | | nm | |
| Solid-Dissolvable | | | | | | | | |
| Composition | | | | | | | | |
| NaC8 | — | | 25 | wt. % | 25 | wt. % | — | |
| NaC10 | 10 | wt. % | 25 | wt. % | — | | 25 | wt. % |
| NaC12 | 40 | wt. % | — | | 25 | wt. % | 25 | wt. % |
| % PMC (dry) | 50 | wt. % | 50 | wt. % | 50 | wt. % | 50 | wt. % |
| Dissolution | | | | | | | | |

| | | | | | |
|---|---|---|---|---|---|
| Mₛ | 12.7 | mg | nm | nm | nm |
| T | 25° | C. | nm | nm | nm |
| M_{A} | 7.08 | wt. % | nm | nm | nm |

TABLE 9

| | Sample CI | | Sample CJ | | Sample CK | | Sample CL | |
|---|---|---|---|---|---|---|---|---|
| | inventive | | inventive | | inventive | | inventive | |
| Process Slurry | | | | | | | | |
| (8) PMC | 38.17 | g | 38.17 | g | 38.17 | g | 38.17 | g |
| (2) NaC8 | 9.47 | g | — | | 4.73 | g | — | |
| (3) NaC10 | — | | 9.47 | g | — | | 4.73 | g |
| (4) NaC12 | — | | — | | — | | — | |
| (1) Water | 2.37 | g | 2.37 | g | 7.10 | g | 7.10 | g |
| ϕ_{PC} | 29.19 | wt. % | 29.19 | wt. % | 26.14 | wt. % | 26.14 | wt. % |
| ϕ_{CA} | 24.81 | wt. % | 24.81 | wt. % | 12.39 | wt. % | 12.39 | wt. % |
| Water Requirement | 1.348 | kg · kg⁻¹ | 1.348 | kg · kg⁻¹ | 2.019 | kg · kg⁻¹ | 2.019 | kg · kg⁻¹ |
| Viscosity (0.1 s⁻¹) | nm | | nm | | nm | | nm | |
| Viscosity (100 s⁻¹) | nm | | nm | | nm | | nm | |
| Solid-Dissolvable | | | | | | | | |
| Composition | | | | | | | | |
| NaC8 | 40 | wt. % | — | | 20 | wt. % | — | |
| NaC10 | — | | 40 | wt. % | — | | 20 | wt. % |
| NaC12 | 10 | wt. % | 10 | wt. % | 30 | wt. % | 30 | wt. % |
| % PMC (dry) | 50 | wt. % | 50 | wt. % | 50 | wt. % | 50 | wt. % |
| Dissolution | | | | | | | | |

| | | | | |
|---|---|---|---|---|
| Mₛ | nm | nm | nm | nm |
| T | nm | nm | nm | nm |
| M_{A} | nm | nm | nm | nm |

### Example 4

EXAMPLE 4 shows comparative example in which compositions prepared with sodium tetradecanoate, sodium hexadecanoate and sodium octadecanoate, which cannot be processed. The process slurry for these compositions are too viscous to be processed, and unsuitable for this invention.

Sample DA-Sample DC show comparative examples, made at compositions shown in Example 3, but using crystallizing agent with a much longer chain length. In concept, the solid-dissolvable compositions also has very high levels of perfume capsules (i.e., 50 wt. %) with high concentrations of perfume capsules (about f_{PC}=30 wt. %) and crystallizing agent (about f_{CA}=30 wt. %) in the process slurry and enabling very low water requirements (1.113 kg·kg⁻¹). In practice, the mixtures where not readily flowable, requiring something akin to ‘kneading bread’ in order to generate anything close to a viable, homogeneous composition. Not wishing to be bound by theory, the flowability of the process slurry among these examples results from the relative long chain length (large hydrophobicity) of the crystallizing agent. Further, even with the struggle in processing, these solid-dissolvable compositions are not readily dissolvable.

All these comparative compositions have unacceptable dissolution as measured by the DISSOLUTION TEST METHOD, and are unsuitable for this invention.

### Process Slurry

A 250-ml stainless steel beaker (Thermo Fischer Scientific, Waltham, MA.) was placed on a hot plate (VWR, Radnor, PA, 7×7 CER Hotplate, cat. no. NO97042-690). Perfume capsule slurry and then fatty acids were added to the beaker, as well as Water (Milli-Q Academic), if needed. A temperature probe was placed into composition. A mixing device comprising an overhead mixer (IKA Works Inc, Wilmington, NC, model RW20 DMZ) and a three-blade impeller design was assembled, with the impeller placed into the composition. The heater was set at 55° C., the impeller was set to rotate at 250 rpm and the composition was heated to 55° C. until all sodium fatty acid carboxylate was added. However, these mixtures were never able to reached homogeneity. Instead, the mixtures where removed from the beaker and kneaded like bread in order to generate any sort of viable composition.

### Crystallizing

These compositions were forced into polymer mold containing a pattern of 5 mm diameter hemispheres, evenly dispersed using a rubber baking spatula, and excess material was scraped from the top of the mold. The mold was placed in a refrigerator (VWR Door Solid Lock F Refrigerator 115V, 76300-508, or equivalent) equilibrated to 4° C. for 24 hours allowing the crystallizing agent to crystallize, as a single-temperature step.

### Drying

The molds were placed in a convection oven (Yamato, DKN400, or equivalent) set to 25° C. with air circulating for another 24 hours. The beads were then removed from the mold and collected.

TABLE 10

| | Sample DA | | Sample DB | | Sample DC | |
|---|---|---|---|---|---|---|
| | comparative | | comparative | | comparative | |
| Process Slurry | | | | | | |
| (8) PMC Slurry | 100.00 | g | 100.00 | g | 100.00 | g |
| (2) NaC8 | — | | — | | — | |
| (3) NaC10 | — | | — | | — | |
| (4) NaC12 | — | | — | | — | |
| (5) NaC14 | 31.00 | g | — | | — | |
| (6) NaC16 | — | | 31.00 | g | — | |
| (7) NaC18 | — | | — | | 31.00 | g |
| (1) Water | — | | — | | — | |
| ϕ_{PC} | 31.00 | wt. % | 31.00 | wt. % | 31.00 | wt. % |
| ϕ_{CA} | 31.00 | wt. % | 31.00 | wt. % | 31.00 | wt. % |
| Water Requirement | 1.113 | kg · kg⁻¹ | 1.113 | kg · kg⁻¹ | 1.113 | kg · kg⁻¹ |
| Viscosity (0.1 s⁻¹) | Too thick | | Too thick | | Too thick | |
| Viscosity (100 s⁻¹) | Too thick | | Too thick | | Too thick | |
| Solid-Dissolvable | | | | | | |
| Composition | | | | | | |
| NaC8 | — | | — | | — | |
| NaC10 | — | | — | | — | |
| NaC12 | — | | — | | — | |
| NaC14 | 50.00 | wt. % | — | | — | |
| NaC16 | — | | 50.00 | wt. % | — | |
| NaC18 | — | | — | | 50.00 | wt. % |
| % PMC (dry) | 50.00 | wt. % | 50.00 | wt. % | 50.00 | wt. % |
| Dissolution | | | | | | |

| | | | | | |
|---|---|---|---|---|---|
| Mₛ | 20.3 | mg | 19.6 | mg | nm |
| T | 25° | C. | 25° | C. | nm |

| | | | |
|---|---|---|---|
| M_{A} | 2.4% | 3.0% | nm |

### Example 5

EXAMPLE 5 shows inventive solid-dissolvable compositions prepared by the inventive, single-temperature process in which blends of sodium octanoate, sodium decanoate, are sodium dodecanoate are added directly to the perfume capsule slurry, crystallized in a single-temperature step, and dried to create the solid-dissolvable compositions with high levels of perfume microcapsules with acceptable water requirements.

Sample EA-Sample EC (in combination with Example 1, Example 2 and Example 3) show that solid-dissolvable compositions with very high levels of perfume capsules (i.e., between 32 wt. %-50 wt. %), can be achieved with different perfume capsule architectures. This is a surprising result, as the flowability of the process slurry is known to be dependent on the concentration of the perfume capsules (i.e., ϕ_{PC}) and crystallizing agent (i.e., ϕ_{CA}) and otherwise expect that a change in the perfume capsule architectures would be a significant impact on the dispersed particle rheology. Nonetheless, each changes allows viable processability, and compositions prepared with inventive water requirements and good dissolution properties.

All these inventive compositions have acceptable dissolution as measured by the DISSOLUTION TEST METHOD.

### Process Slurry

A 250-ml stainless steel beaker (Thermo Fischer Scientific, Waltham, MA.) was placed on a hot plate (VWR, Radnor, PA, 7×7 CER Hotplate, cat. no. NO97042-690). Perfume capsule slurry and then fatty acids were added to the beaker, as well as Water (Milli-Q Academic), if needed. A temperature probe was placed into composition. A mixing device comprising an overhead mixer (IKA Works Inc, Wilmington, NC, model RW20 DMZ) and a three-blade impeller design was assembled, with the impeller placed into the composition. The heater was set at 55° C., the impeller was set to rotate at 250 rpm and the composition was heated to 55° C. until all the sodium fatty acid carboxylate was added and mixed until reaching homogeneity and no large particulates could be seen in the beaker.

### Crystallizing

The composition was transferred to polymer mold containing a pattern of 5 mm diameter hemispheres, evenly dispersed using a rubber baking spatula, and excess material was scraped from the top of the mold. The mold was placed in a refrigerator (VWR Door Solid Lock F Refrigerator 115V, 76300-508, or equivalent) equilibrated to 4° C. for 24 hours allowing the crystallizing agent to crystallize, as a single-temperature step.

### Drying

The molds were placed in a convection oven (Yamato, DKN400, or equivalent) set to 25° C. with air circulating for another 24 hours. The beads were then removed from the mold and collected.

TABLE 11

| | Sample EA | | Sample EB | | Sample EC | |
|---|---|---|---|---|---|---|
| | Inventive | | Inventive | | Inventive | |
| Process Slurry | | | | | | |
| (14) PMC Slurry | 100.00 | g | — | | — | |
| (15) PMC Slurry | — | | 100.00 | g | — | |
| (16) PMC Slurry | — | | — | | 100.00 | g |
| (17) PMC Slurry | — | | — | | — | |
| (2) NaC8 | 6.77 | g | 6.77 | g | 5.83 | g |
| (3) NaC10 | 6.77 | g | 6.77 | g | 5.83 | g |
| (4) NaC12 | 20.31 | g | 20.31 | g | 17.49 | g |
| (1) Water | — | | — | | — | |
| ϕ_{PC} | 21.00 | wt. % | 21.00 | wt. % | 32.00 | wt. % |
| ϕ_{CA} | 30.00 | wt. % | 30.00 | wt. % | 30.01 | wt. % |
| Water Requirement | 1.440 | kg · kg⁻¹ | 1.440 | kg · kg⁻¹ | 1.112 | kg · kg⁻¹ |
| Viscosity (0.1 s⁻¹) | nm | | nm | | nm | |
| Viscosity (100 s⁻¹) | nm | | nm | | nm | |
| Solid-Dissolvable | | | | | | |
| Composition | | | | | | |
| NaC8 | 12.3 | wt. % | 12.3 | wt. % | 9.5 | wt. % |
| NaC10 | 12.3 | wt. % | 12.3 | wt. % | 9.5 | wt. % |
| NaC12 | 37.0 | wt. % | 37.0 | wt. % | 28.6 | wt. % |
| % PMC (dry) | 38.3 | wt. % | 38.3 | wt. % | 52.3 | wt. % |
| Dissolution | | | | | | |
| Mₛ | 22.7 | mg | 16.4 | mg | 17.1 | mg |
| T | 25° | C. | 25° | C. | 25° | C. |
| M_{A} | 22.4 | wt. % | 20.5 | wt. % | 45.3 | wt. % |

### Example 6

EXAMPLE 6 shows inventive solid-dissolvable compositions prepared by the inventive, two-temperature step process in which blends of sodium octanoate, sodium decanoate, are sodium dodecanoate are added directly to the perfume capsule slurry, crystallized in a two-temperature step, and dried to create the solid-dissolvable compositions with high levels of perfume microcapsules with acceptable water requirements. In this example, the two-temperature process—in particular the temperatures of the two step, is critical to optimizing the speed of crystallization and firmness of the resulting composition. Both of these aspects are critical to commercial execution.

Example FA-FB show the effect of two-temperature crystallization on the rate of crystallization, and resulting firmness of the solid-dissolvable composition. Example FA (FIG. 9A) is the most preferred process embodiment, in which the process slurry is first cooled to 25° C. (pre-crystallization and/or partial crystallization) until reaching steady-state and then further cooled to 5° C. (final crystallization). The final crystallization is initiated ‘instantaneously’ (ΔT=0) and the composition are firmer (Time (G′₁₀₀₀)=200 seconds). Example FB (FIG. 9A) is a preferred process embodiment, in which the process slurry remains at 40° C. (no pre-crystallization and/or partial crystallization) and then further cooled to 5° C. (final crystallization) in a single step. The final crystallization requires significant time to imitate (ΔT>750 seconds) and the composition are firmer (Time (G′₁₀₀₀)=1000 seconds).

These two examples are non-limiting, as it is thought that a similar results may be obtained with other pre-crystallization temperatures. With this composition of the process slurry at 40° C. has 0% of the crystallizing agent is crystallized, at 5° C. has 100% of the crystallizing agent is crystallized, and at 25° C. has some fraction of the crystallizing agent is crystallized. Having some fraction of crystals in the process slurry when further cooling speeds the crystallization process. It is anticipated that other temperature with partial crystallization on the process slurry may be suitable for the process invention, with the stipulation that viscosity of the process slurry with the crystals and at the temperature, does not exceed the specified limits.

### Process Slurry

A 250-ml stainless steel beaker (Thermo Fischer Scientific, Waltham, MA.) was placed on a hot plate (VWR, Radnor, PA, 7×7 CER Hotplate, cat. no. NO97042-690). Perfume capsule slurry and then fatty acids were added to the beaker, as well as Water (Milli-Q Academic), if needed. A temperature probe was placed into composition. A mixing device comprising an overhead mixer (IKA Works Inc, Wilmington, NC, model RW20 DMZ) and a three-blade impeller design was assembled, with the impeller placed into the composition. The heater was set at 55° C., the impeller was set to rotate at 250 rpm and the composition was heated to 55° C. until all fatty acids were emulsified. Once the composition had reached homogeneity, aqueous sodium hydroxide was added to the beaker in a dropwise fashion. The resulting composition was kept under the mixing conditions until homogeneity was reached again and no large particulates could be seen in the beaker.

### Crystallizing

The process slurry is applied to the rheometer in accordance with the MODULUS TEST METHOD. The values for crystallization are reported in the table.

TABLE 12

| | Sample FA Inventive | | Sample FB Inventive | |
|---|---|---|---|---|
| Process Slurry | | | | |
| (8) PMC Slurry | 8.55 | g | 8.55 | g |
| (11) Fatty Acid | 5.27 | g | 5.27 | g |
| Blend: C810L | | | | |
| (12) Lauric Acid | 8.12 | g | 8.12 | g |
| (13) 50 wt. % NaOH | 5.95 | g | 5.95 | g |
| (1) Water | 22.14 | g | 22.14 | g |
| ϕ_{PC} | 7.87 | wt. % | 7.87 | wt. % |
| ϕ_{CA} | 32.58 | wt. % | 32.58 | wt. % |
| Water Requirement | | | | |
| Viscosity (0.1 s⁻¹) | nm | | nm | |
| Viscosity (100 s⁻¹) | nm | | nm | |
| Solid-Dissolvable | | | | |
| Composition | | | | |
| NaC8 | 19.3 | wt. % | 19.3 | wt. % |
| NaC10 | 14.7 | wt. % | 14.7 | wt. % |
| NaC12 | 51.0 | wt. % | 51.0 | wt. % |
| % PMC (dry) | 15.0 | wt. % | 15.0 | wt. % |
| Crystallization | | | | |
| Temperature | 40° | C. | 25° | C. |
| ΔT | 0 | s | 750 | s |
| Time (G′₁₀₀₀) | 200 | s | >1000 | s |

What is claimed is:

1. A process of making a solid-dissolvable composition comprising:
a) providing a perfume capsule slurry comprising perfume capsules and water, wherein the perfume capsules have a mass of perfume capsules and the water has a perfume capsule slurry water mass;
b) creating a process slurry by mixing the perfume capsule slurry with a crystallizing agent having a mass of crystallizing agent, and adding from about 0% to about 30%, by weight of the process slurry, extra water, having an extra water mass;
i) wherein the low shear viscosity (Viscosity (0.1 s⁻¹)) of the process slurry is less than about 100 Pa·s and the high shear viscosity (Viscosity (100 s⁻¹)) of the process slurry is less than about 2 Pa·s as determined by the RHEOLOGY TEST METHOD;
ii) wherein the water requirement of the process slurry is less than about 2.0 kg·kg⁻¹; and
iii) wherein the process slurry is such that the (mass of perfume capsules)/(mass of perfume capsules+mass of crystallizing agent) is greater than 0.2;
c) crystallizing the crystallizing agent;
d) drying to remove water until the solid dissolvable composition comprises less than 10 wt % water.

2. The process of claim 1, further comprising the step of adding a freshness benefit agent selected from a neat perfume, a pro-perfume, an encapsulated starch, and mixtures thereof.

3. The process of claim 2, wherein the freshness benefit agent is perfume and/or pro-perfume and is sprayed onto the solid-dissolvable composition after drying.

4. The process of claim 1, wherein the crystallizing agent is selected from sodium octanoate, sodium decanoate, sodium dodecanoate, and mixtures thereof.

5. The process of claim 1, wherein the process slurry has a ϕ_{CA} of less than about 35 wt. %.

6. The process of claim 1, wherein the process slurry has a ϕ_{PC} of less than about 40 wt. %.

7. The process of claim 1, wherein the crystallization is a two-temperature step process, wherein the temperature of the first step is between 20° C. and 30° C., and wherein the temperature of the second step is between 1° C. and 15° C.

8. The process of claim 1, wherein the crystallization has an elastic modulus (G′) that grows to 10³ Pa in less than 300 seconds as determined by the MODULUS TEST METHOD.

9. The process of claim 1, wherein the crystallization has a delay time (ΔT) of less than 100 seconds as determined by the MODULUS TEST METHOD.

10. The process of claim 1, wherein the solid-dissolvable composition comprises from about 12% to about 70% perfume capsules.

11. A solid-dissolvable composition comprising:
crystallizing agent;
water; and
about 20 wt. % to about 70 wt. % perfume capsules;
wherein the crystallizing agent is selected from sodium octanoate (NaC8), sodium decanoate (NaCl0), sodium dodecanoate (NaCl2), and combinations thereof; and
wherein the crystallizing agent is in the form of fibers, as determined by the FIBER TEST METHOD.

12. The solid dissolvable composition of claim 11, wherein the sodium salt of saturated fatty acids of the crystallizing agent comprises from 50 wt. % to 70 wt. % NaCl2, 15 wt. % to 25 wt. % NaCl0, and 15 wt. % to 25 wt. % NaC8.

13. The solid-dissolvable composition of claim 11, wherein the amount of water is less than about 10 wt. %.

14. The solid-dissolvable composition of claim 11, wherein the perfume capsules comprise a shell comprising material selected from urea, methyl formaldehyde, silica, chitosan, and mixtures thereof.

15. The solid-dissolvable composition of claim 11, wherein the composition has a mass from about 5 mg to about 100 mg.

16. The solid-dissolvable composition of claim 11, wherein the dissolution of the composition is such that M_{A}>5%.

17. The solid-dissolvable composition of claim 11, wherein the fibers of the crystallizing agent form a mesh having a density of less than about 0.90 g cm⁻³.

18. The solid-dissolvable composition of claim 11, further comprising a freshness benefit agent, selected from a neat perfume, a pro-perfume, a starch encapsulate, and mixtures thereof.

19. A fabric treatment, wherein one or more solid-dissolvable compositions of claim 11 are added to a wash drum at the start of a laundry cycle.

20. The solid-dissolvable composition of claim 11, wherein the solid-dissolvable composition is dispersed in polyethylene glycol (PEG).
